(19) United States
(12) Patent Application Publication
(10) Pub. No.: US 2021/0264263 A1
(43) Pub. Date: Aug. 26, 2021

(54) CONTROL OF HYPERPARAMETER TUNING BASED ON MACHINE LEARNING

(71) Applicant: Capital One Services, LLC, McLean, VA (US)

(72) Inventors: Austin Grant WALTERS, Savoy, IL (US); Jeremy Edward GOODSITT, Champaign, IL (US); Anh TRUONG, Champaign, IL (US); Mark Louis WATSON, Sedona, AZ (US)

(73) Assignee: Capital One Services, LLC, McLean, VA (US)

(21) Appl. No.: 17/173,970

(22) Filed: Feb. 11, 2021

Related U.S. Application Data
(63) Continuation-in-part of application No. 16/799,227, filed on Feb. 24, 2020.

(51) Int. Cl. G06N 3/08; G06K 9/62

(52) U.S. Cl. CPC G06N 3/08; G06K 9/6262; G06K 9/6261; G06K 9/6231

(57) ABSTRACT

Systems, methods, articles of manufacture, and computer program products to train a generation model to determine whether a search space portion is likely to provide hyperparameters that improve a success metric; sequentially select at least a subset of multiple search space portions; for each selected search space portion, generate hyperparameters from the search space portion, perform hyperparameter tuning with the hyperparameters to determine whether the hyperparameters improved the success metric, apply the generation model based on whether the success metric is improved to determine whether the search space portion is likely to provide further hyperparameters that improve the success metric, and rule out the search space portion from providing further hyperparameters in response to determining that the search space portion is unlikely to provide further hyperparameters that improve the success metric; and terminate the performance of hyperparameter tuning when all search space portions are ruled out.

### CROSS-REFERENCE TO RELATED APPLICATIONS

This application is a continuation-in-part of, and claims the benefit of priority under 35 U.S.C. § 120 to, U.S. patent application Ser. No. 16/799,227 filed Feb. 24, 2020.

### TECHNICAL FIELD

Embodiments herein generally relate to computing platforms, and more specifically, to controlling the optimization of hyperparameters for an artificial intelligence (AI) model.

### BACKGROUND

It has become commonplace to use AI models to perform any of a wide variety of functions. However, while some aspects of preparing an AI model to perform a function have become relatively well defined and understood, other aspects may require time consuming experimentation. For example, while there may be considerable information available concerning the most effective type of AI model to use for performing some functions (e.g., visual recognition), there may be a relative lack of such information available for other functions such that the determination of which type of AI model to use may require some degree of trial and error experimentation. Additionally, even where the type of AI model that is deemed to be best for use in performing a particular function may be well known, there may be a relative lack of information available concerning tuning various configuration aspects of an implementation of that AI model to perform that function. Such configuration aspects are often referred to as “hyperparameters” to distinguish them from the parameters that are learned by training. It may be that deriving the hyperparameters may also require some degree of time consuming trial and error experimentation.

### SUMMARY

Embodiments disclosed herein provide systems, methods, articles of manufacture, and computer-readable media for the use of machine learning to control the tuning of hyperparameters of an AI model. In one example, an apparatus includes a non-transitory computer-readable medium storing a set of hyperparameters for an AI model, the hyperparameters configured to be adjusted according to a hyperparameter selection technique based on one or more parameters, and a processor. The processor is configured to train a prediction model using a machine learning process, the prediction model configured to estimate whether further application of the hyperparameter selection technique will cause an improvement in at least one of the hyperparameters; select the hyperparameters using the hyperparameter selection technique; and apply the prediction model to determine if further adjustment of the hyperparameters is likely to improve the success metric. The processor is further configured to terminate the hyperparameter selection technique when either: an accuracy of the prediction model in predicting improvement in at least one of the hyperparameters is above a predetermined accuracy threshold, and the prediction model predicts that further application of the hyperparameter selection technique will not result in an improvement to the hyperparameter; or the accuracy of the prediction model in predicting improvement in the hyperparameter is below the predetermined accuracy threshold, and an accuracy of hyperparameter adjustment is determined to be below a predetermined adjustment accuracy threshold. Alternatively or additionally, the processor is further configured to train a generation model using a machine learning process, the generation model configured to progressively reduce the hyperparameter search space from which new candidate sets of hyperparameters are generated for purposes of being considered for being tested and evaluated for selection as part of the hyperparameter selection technique.

### BRIEF DESCRIPTION OF THE DRAWINGS

FIG. 1 illustrates an embodiment of a system that tunes hyperparameters of an AI model.

FIG. 2 illustrates an embodiment of a requesting device that specifies a type of AI model.

FIG. 3 illustrates an embodiment of a data device that provides training and testing data.

FIG. 4 illustrates an embodiment of a tuning device that tunes hyperparameters of an AI model.

FIG. 5 illustrates an embodiment of a node device that performs a portion of tuning of hyperparameters of an AI model.

FIGS. 6A-6D, taken together, illustrate an embodiment of a performance of tuning of hyperparameters.

FIGS. 7A-C, taken together, illustrate an embodiment of control of a performance of tuning of hyperparameters.

FIGS. 8A-E, taken together, illustrate another embodiment of control of a performance of tuning of hyperparameters.

FIGS. 9A-F, taken together, illustrate an embodiment of generation of sets of hyperparameters of an AI model based on a hyperparameter search space.

FIGS. 10A-10E, together, illustrate an embodiment of a first logic flow.

FIGS. 11A-11E, together, illustrate an embodiment of a second logic flow.

FIG. 12 illustrates an embodiment of a computing architecture.

### DETAILED DESCRIPTION

Embodiments disclosed herein use machine learning to control the tuning of hyperparameters of an AI model specified to be used to perform a particular function. Generally, as the tuning of hyperparameters for the AI model begins, evaluations of the results of initial iterations of such tuning may be used to train one or more prediction models. During subsequent iterations of such tuning, the one or more prediction models may then be used to generate predictions concerning the efficacy of subsequent iterations of such tuning as part of determining when to cease such tuning. Alternatively or additionally, as iterations of tuning of hyperparameters for the AI model are performed, the results of the evaluation of each iteration may be used to train one or more generation models. The one or more generation models may be used to progressively reduce the size of the hyperparameter search space from which new candidate sets of hyperparameters are generated to be at least considered for testing and evaluation during the iterations of tuning.

The performance of iterations of tuning of hyperparameters for an AI model may begin in response to the receipt of a request to do so, wherein the request may specify the AI model, the hyperparameter search space, a single set of hyperparameters that define a starting point within the hyperparameter search space, a data set to be used in training and/or testing each instance of the AI model that is used to test a single set of hyperparameters, the evaluation criteria to be used in evaluating the results of each test of a single set of hyperparameters, and/or the one or more prediction models to be used in generating predictions. The function that the AI model is to perform may be any of wide variety of functions for which an output is to be generated in response to data values provided to the inputs of the AI model. The AI model, each of the one or more prediction models and/or each of the one or more generation models may employ any of a wide variety of types of machine learning techniques.

For each iteration of performance of the tuning of hyperparameters for the AI model, a set of the hyperparameters that fall within the hyperparameter search space may be generated using any of a variety of techniques, including randomly. For each single set of hyperparameters that is to be tested, an instance of the AI model may be instantiated based on that single set, and that instance of the AI model may then be trained using the data set. That instance of the AI model may then be tested using the data set, and the results of the testing may be evaluated based on the evaluation criteria. Such an evaluation may entail the generation of a metric from the results of the testing, followed by the comparison of the metric to one or more thresholds.

During a training mode, as the initial iterations of the tuning of hyperparameters are performed, the one or more prediction models may be trained based on each set of hyperparameters that is tested and the corresponding evaluation of the results of the testing thereof based on the evaluation criteria. Following the training mode, the one or more prediction models may then be used in a prediction mode to make predictions concerning what the results of the testing of each set of hyperparameters will be. The predictions may be employed to determine whether or not to proceed with consuming the time, processing resources, storage resources and/or other resources necessary to test each set of hyperparameters. Where a determination is made to proceed with the testing of a set of hyperparameters, the evaluation of the results of that testing may be used to determine the degree of success of the one or more prediction models in making the predictions on which such determinations are based. In some embodiments, where the degree of success falls below a predetermined threshold, the training mode may be re-entered as the one or more prediction models may be further trained based on more sets of hyperparameters and corresponding evaluations of the results of the testing thereof.

It may be that the generation of sets of hyperparameters is at least initially controlled in one way during the training mode to at least emphasize the generation of sets of hyperparameters that are widely distributed throughout the hyperparameter search space so as to enhance the training of the one or more prediction models. By way of example, such initial sets of hyperparameters may be generated from widely dispersed locations throughout the hyperparameter search space. Subsequently, it may be that the generation of sets of hyperparameters is controlled in a different way during the prediction mode to at least begin with the generation of sets of hyperparameters that cover portions of the hyperparameter search space that are relatively close to the starting point. As more ever more hyperparameters are required to be generated (e.g., as the prediction mode continuous to last ever longer), the sets of hyperparameters that are generated may cover portions of the hyperparameter search space that are increasingly further away from the starting point.

Regardless of the exact strategies that may be employed in selecting portions of the hyperparameters search space from which to generate sets of hyperparameters, the manner in which such strategies may be effected may be at least partially based on the training and use of the one or more generation models, either in addition to, or in lieu of, the provision and use of the one or more prediction models. More specifically, the results of each iteration of the tuning of hyperparameters may be used to train the one or more generation models to progressively refine the generation of sets of hyperparameters for each subsequent iteration by excluding ever more portions of the hyperparameter search space from which sets of hyperparameters were previously generated that did not bring about an improvement in the tuning of hyperparameters. Such ongoing training of the one or more generation models may also be at least partially based on predictions made by the one or more prediction models, although it may be that reliance on those predictions may be conditioned on the one or more prediction models having achieved a predetermined degree of accuracy in making predictions.

In some embodiments, advantage may be taken of the availability of processing resources and/or storage resources that enable the generation and/or testing of batches of multiple sets of hyperparameters to be performed in parallel. In such embodiments, determinations may be made (based on predictions made by the one or more prediction models) of whether to proceed with the testing of batches of multiple sets of hyperparameters, instead of whether to proceed with the testing of individual sets of hyperparameters.

Advantageously, embodiments disclosed herein enable time, processing resources, storage resources and/or other valuable resources to be utilized more efficiently by using the learned history of the results of earlier testing of sets of hyperparameters for a specified AI model within a specified hyperparameter search space as a basis for determining whether or not there is efficacy to continuing with further testing of hyperparameters. In this way, such resources may be better utilized for the testing of hyperparameters for a different AI model and/or within a different hyperparameter search space. Also advantageously, such use of such a learned history is able to be scaled up to be used across numerous processing cores within a single device and/or across numerous interconnected devices.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

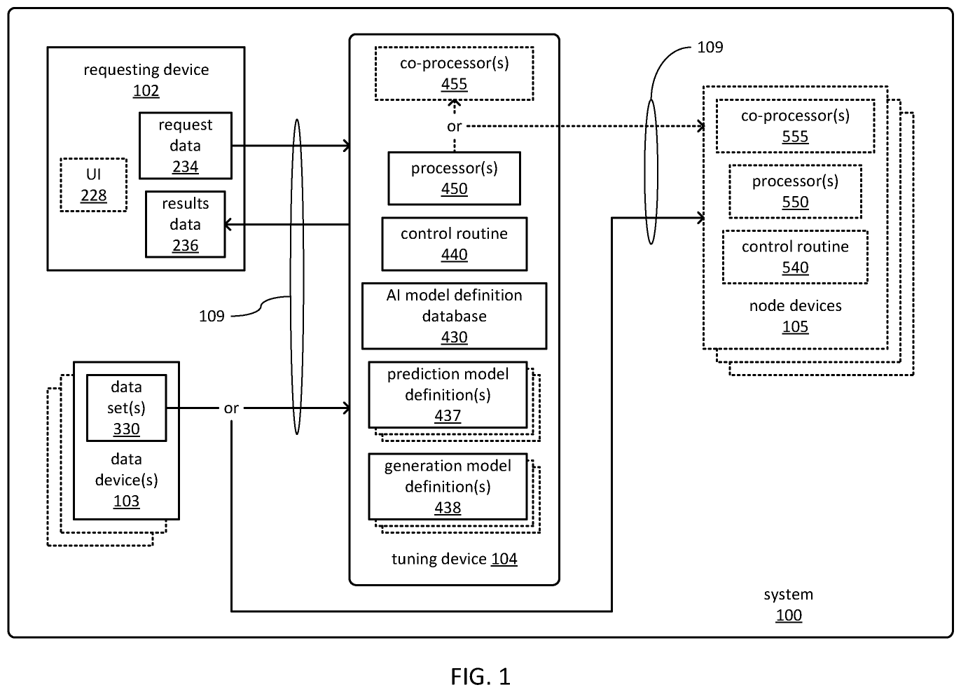

FIG. 1 depicts a schematic of an exemplary system 100 for the tuning of hyperparameters of an AI model, consistent with disclosed embodiments. As shown, the system 100 may include a requesting device 102, one or more data devices 103, a tuning device 104, and/or one or more node devices 105. The requesting device 102 may provide the tuning device 104 with request data 234 conveying details of a request to tune the hyperparameters of an AI model. The one or more data devices 103 may provide the tuning device 104 with a training data and/or testing data for use in such tuning. As will be explained in greater detail, in some embodiments, the tuning device 104 may employ its own processing and/or storage resources to perform such tuning. However, in other embodiments, the tuning device 104 may distribute portions of the performance of such tuning among the one or more node devices 105 to employ the processing and/or storage resources the one or more node devices 104 to perform those portions of such tuning.

As also shown, the devices 102, 103, 104 and/or 105 may be interconnected via a network 109, by which these devices may exchange information associated with the requested tuning of hyperparameters as just described. However, one or more of these devices may also exchange other data entirely unrelated to such tuning with each other and/or with still other devices (not shown) via the network 109. In various embodiments, the network 109 may be a single network possibly limited to extending within a single building or other relatively limited area, a combination of connected networks possibly extending a considerable distance, and/or may include the Internet. The network 109 may be based on any of a variety (or combination) of communications technologies by which signals may be exchanged, including and without limitation, wired technologies employing electrically and/or optically conductive cabling, and wireless technologies employing infrared, radio frequency or other forms of wireless transmission.

The requesting device 102 may provide a user interface (UI) 228 to an operator thereof by which the operator may specify various aspects of the AI model and/or of the hyperparameters thereof that are to be tuned. The requesting device 102 may then transmit, to the tuning device 104, the request data 234 in which such aspects are specified as part of providing the tuning device 104 with the request for the performance of such tuning. Upon completion of the performance of such tuning, the requesting device 102 may receive results data 236 specifying whether the such tuning was successful, and if so, a set of the hyperparameters generated by such tuning.

The one or more data devices 103 may serve as the source of a data set 330 that may be used in training and then testing a separate instance of the AI model for each set of hyperparameters that is tested during the tuning of the hyperparameters. In embodiments in which the data set 330 is particularly large in size, the system 100 may include more than one of the data devices 103 to provide distributed storage of such data sets 330. The request data 234 may include an identifier of the data set 330 that is to be used during such tuning to enable the tuning device 104 and/or the one or more node devices 105 to directly retrieve the data set 330 from the one or more data devices 103 via the network 109.

Whether the data set 330 is retrieved by the tuning device 104 or the one or more node devices 105 may depend on whether portions of the performance of the tuning of the hyperparameters are distributed by the tuning device 104 among the one or more node devices 105. In embodiments in which the system 100 includes more than one of the node devices 105, those multiple node device 105 may be interconnected through the network 109 to form a distributed processing grid.

Each of these devices 102, 103, 104 and/or 105 may be representative of any type of computing device, such as a server, desktop computer, laptop computer, smartphone, virtualized computing system, compute cluster, portable gaming device, etc.

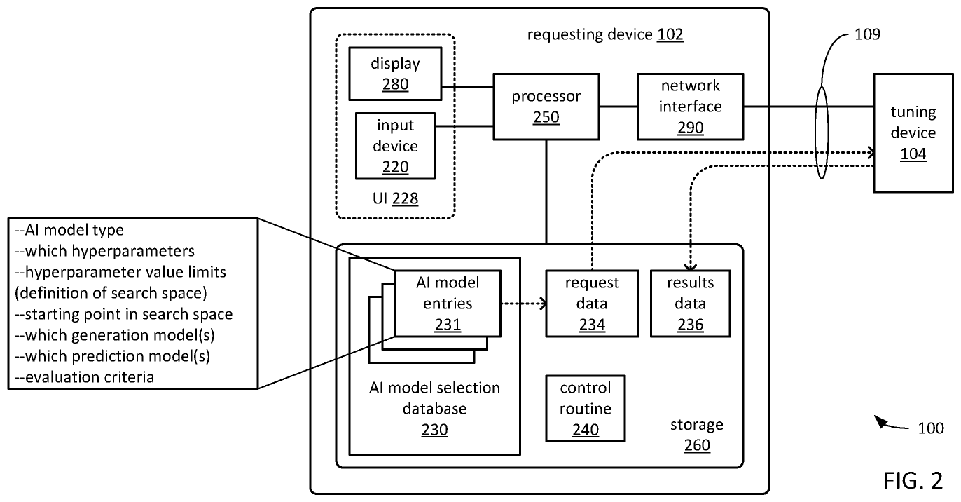

FIG. 2 depicts a schematic of an exemplary embodiment of the requesting device 102. As shown, the requesting device 102 may include a processor 250, a storage 260, an input device 220, a display 280 and/or a network interface 290 to couple the requesting device 102 to a network, such as the network 109. The storage 260 may store the request data 234, the results data 236, an AI model selection database 230 and/or a control routine 240. The control routine 240 may include executable instructions operable on the processor 250 to cause the processor 250 to implement logic to perform various functions.

The AI model selection database 230 may include multiple AI model entries 231. Each entry 231 may correspond to a single AI model, and may include indications of various details of the corresponding AI model, such as a specification of what hyperparameters are associated with the corresponding AI model and/or limits of the range or set of values for one or more of those hyperparameters. Each of the AI models that corresponds to one of the entries 231 may be any of a variety of type(s) of machine learning model, including and not limited to, neural networks of various types (e.g., convolutional neural network, feedforward neural network, recurrent neural network, etc.), variational autoencoders, generative adversarial networks (GAN) or cycleGAN, capsule networks based on capsules of multiple artificial neurons, learning automata based on stochastic matrices, evolutionary algorithms based on randomly generated code pieces, etc.

The hyperparameters associated with each AI model may specify any of a variety of upper and/or lower boundaries on the size of various aspects of the configuration thereof, and/or still other aspects of the configuration thereof. By way of example, the hyperparameters for an implementation of a particular type of neural network may include the overall quantity of artificial neurons, the quantity of layers of artificial neurons, the quantity of sets of training values used in training, the activation function(s) of the artificial neurons, weights and/or biases associated with the activation function(s), etc.

In executing the control routine 240, the processor 250 may be caused to operate the display 280 and the input device 220 to provide the UI 228 in which a listing of AI models drawn from the entries 231 may be presented to an operator of the requesting device 102 from which to select the AI model for which hyperparameters are to be tuned. Upon selecting the AI model, the processor 250 may be further caused to present the operator with indications of what hyperparameters are associated with that AI model for being tuned, and/or indications of the limits of the range or set of values for one or more of them. In this way, the operator may be provided with an indication of the full extent of the available hyperparameter search space to enable the operator to specify a portion thereof as the hyperparameter search space that is to be covered during the tuning of the hyperparameters. Such a presentation may also enable the operator to specify the initial set of hyperparameters that define the starting point within the specified hyperparameter search space at which the tuning of the hyperparameters is to begin.

In some embodiments, each of the entries 231 of the AI model selection database 230 may also specify one or more evaluation criteria to be used in evaluating sets of hyperparameters during the tuning thereof, and/or to be used in determining when to cease such tuning. In some embodiments, the evaluation criteria may include a specified threshold of performance that is to be met by a metric derived from an evaluation of the outputs of the AI model, directly, such as a degree of accuracy in performing a particular function. However, in other embodiments, the evaluation criteria may include a specified threshold of a post-AI function into which the AI model provides its outputs as inputs. Such a post-AI function may, in turn, have one or more outputs that are desired to be minimized, maximized and/or generated to be as close as possible to a predetermined value. Thus, in such other embodiments, the evaluation criteria may include a specified threshold by which, for example, an output generated by a post-AI function from the outputs of the AI model is to be minimized, such as an error value, a value quantifying noise, a value quantifying a loss, etc.

Following the selection of the AI model and/or the specification of various other aspects of the tuning of the hyperparameters for the AI model, the processor 250 may be caused to operate the network interface 290 to transmit the request for the performance of such tuning to the tuning device 104 via the network 109, including the transmission of the request data 234 conveying such information. The request data 234 may specify one or more of: the AI model for which hyperparameter tuning is to be performed; which hyperparameters of the AI model are to be so tuned; ranges and/or other indications of limits on the possible values for each of the hyperparameters, and/or a different form of definition of the hyperparameter search space; an initial set of hyperparameters that defines the starting point within the search space at which hyperparameter tuning is to begin; a data set 330 for training and testing instances of the AI model to test sets of hyperparameters; a selection of one or more generation models to be used in refining the generation of sets of hyperparameters as iterations of hyperparameter tuning are performed; a selection of one or more prediction models to be used in making predictions concerning the expected efficacy of further iterations of hyperparameter tuning; and evaluation criteria to be used in determining at least when to cease performing iterations of hyperparameter tuning.

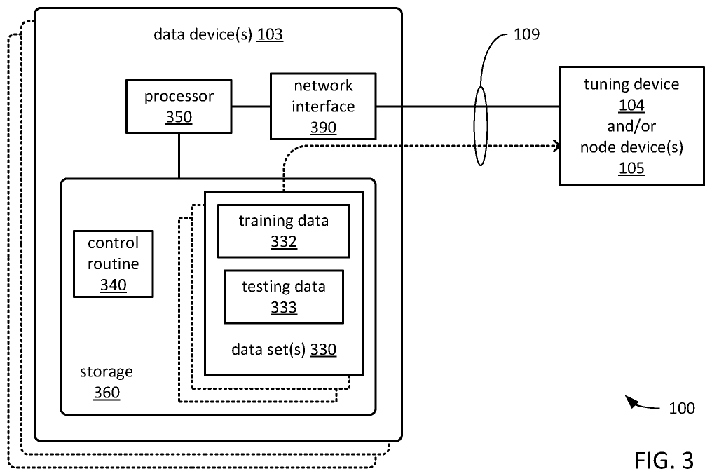

FIG. 3 depicts a schematic of an exemplary embodiment of each of the one or more data devices 103. As shown, each of the one or more data devices 103 may include a processor 350, a storage 360 and/or a network interface 390 to couple the data device 103 to a network, such as the network 109. The storage 360 may store the one or more data sets 330 and/or a control routine 340. The control routine 340 may include executable instructions operable on the processor 350 to cause the processor 350 to implement logic to perform various functions.

Each of the one or more data sets 330 may include any of a wide variety of types of data associated with any of a wide variety of subjects. By way of example, each data set 330 may include scientific observation data concerning geological and/or meteorological events, or from sensors employed in laboratory experiments in areas such as particle physics. By way of another example, each data set 330 may include indications of activities performed by a random sample of individuals of a population of people in a selected country or municipality, or of a population of a threatened species under study in the wild.

In some embodiments, each of the one or more data sets 330 may include specifically designated training data 332 by which each instance of the AI model is to be trained during the tuning of the hyperparameters, and/or specifically designated testing data 333 by which each such instance of the AI model is to be tested. In other embodiments, such a division of the data set 330 used in such tuning may not be performed until such tuning is performed.

Execution of the control routine 340 may cause the processor 350 to operate the network interface 390 to receive requests to store data sets 330 received from other devices via the network 109, and/or requests to retrieve and provide data sets 330 to other devices. More specifically, in embodiments in which the system 100 includes just one of the data device 103, the processor 350 may store entire data sets 330 within the single data device 103, and/or retrieve an entire data set 330 in response to a request received via the network 109 to provide that data set 330. Alternatively, in embodiments in which the system 100 includes more than one of the data device 103, the processors 350 of the multiple data devices 103 may cooperate via the network 109 to coordinate the division of data sets 330 into portions for storage across the multiple data devices 103, and/or to cooperate via the network 109 to coordinate the retrieval and combining of portions of a data set 330 in response to such a request to provide that data set 330.

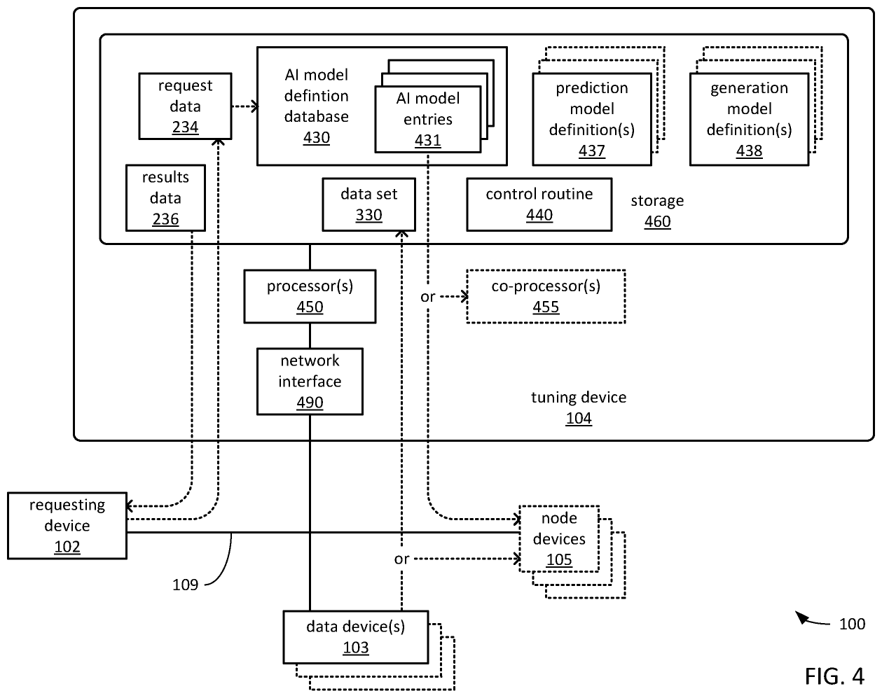

FIG. 4 depicts a schematic of an exemplary embodiment of the tuning device 104. As shown, the tuning device 104 may include one or more processors 450, one or more co-processors 455, a storage 460, and/or a network interface 490 to couple the tuning device 104 to a network, such as the network 109. The storage 460 may store the request data 234, the results data 236, the data set 330, an AI model definition database 430, one or more prediction model definitions 437, one or more generation model definitions 438, and/or a control routine 440. The control routine 440 may include executable instructions operable on the one or more processors 450 to cause at least one thereof to implement logic to perform various functions.

In embodiments in which the tuning device 104 includes the one or more co-processors 455, the one or more co-processors 455 may differ in processing architecture from the one or more processors 450 in a manner that is deemed to make the one or more co-processors 455 more amenable for use in implementing multiple instances of the AI model. More specifically, in some embodiments, each of the one or more co-processors 455 may be a graphics processing unit (GPU) or other type of processing unit that incorporates a relatively large quantity of relatively simple processing cores that enable a highly parallelized performance of relatively simple functions. Such highly parallelized performances of relatively simple functions may enable, for example, a more efficient software-based implementation of numerous neurons of a neural network or of a capsule network. Alternatively, such highly parallelized performances of relatively simple functions may enable highly parallelized performances of computations involving the stochastic matrices of an implementation of learning automata or involving the randomly generated code pieces of an evolutionary algorithm.

Alternatively, in other embodiments in which the tuning device 104 incorporates the one or more co-processors 455, each of the one or more co-processors 455 may be a neuromorphic processing device or other type or processing device that at least partially implements artificial neurons as hardware components (e.g., such as a configurable array of memristors, not specifically shown). Each of such hardware components implementing at least a portion of an artificial neuron may incorporate dedicated memory components to store indications of weights, biases, an activation function, and/or connections to inputs and/or outputs of other hardware components that also at least partially implement other artificial neurons. Such neuromorphic devices may be capable of enabling the faster instantiation, training and/or testing of instances of the AI model.

The AI model definition database 430 may include multiple AI model entries 431. Each entry 431 may correspond to a single AI model, and may include various pieces of information needed to enable the implementation of the corresponding AI model, including and not limited to, indications of various configuration parameters, a copy of configuration data that may be used to directly program one or more neuromorphic devices (e.g., the one or more co-processors 455), or executable instructions that are operative on at least one of the one or more processors 450 and/or the one or more co-processors 455 to directly implement the corresponding AI model in software-based manner.

Each one of the one or more prediction model definitions 437 may similarly correspond to a single prediction model, and may similarly include various pieces of information needed to enable the implementation of the corresponding prediction model. Correspondingly, each of the one or more generation model definitions 438 may similarly correspond to a single generation model, and may similarly include various pieces of information needed to enable the implementation of the corresponding generation model. Unlike the AI model that may be instantiated a relatively large number of times to enable the testing of a corresponding relatively large number of different sets of hyperparameters, each of the one or more prediction models may be implemented just once, and those single implementations of each of the one or more prediction models may remain instantiated throughout the performance of tuning of the hyperparameters of the AI model. Correspondingly, each of the one or more generation models may be implemented just once, and those single implementations of each of the one or more generation models may remain instantiated throughout the performance of tuning of the hyperparameters of the AI model.

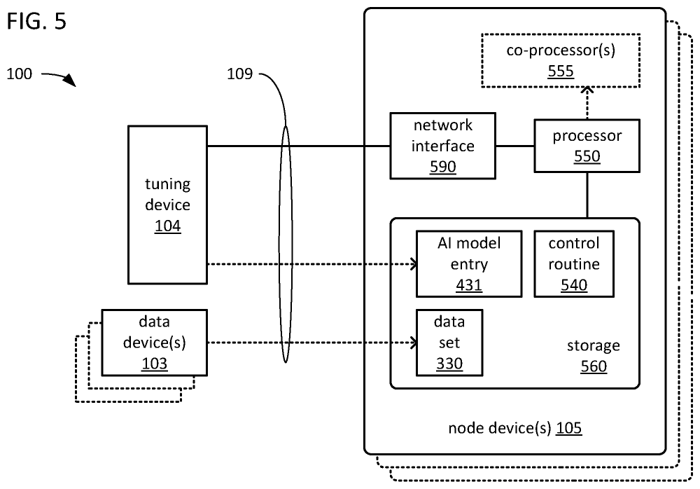

FIG. 5 depicts a schematic of an exemplary embodiment of each of the one or more node devices 105 that may be included in some embodiments of the system 100 in which the one or more node devices 105 are employed in performing at least a portion of the tuning of the hyperparameters of the AI model. As shown, each of the one or more node devices 105 may include one or more processors 550, one or more co-processors 555, a storage 560 and/or a network interface 590 to couple the node device 105 to a network, such as the network 109. The storage 560 may store the data set 330 specified in the request data 234, a control routine 540, and/or a copy of the AI model entry 431 retrieved by the processor(s) 450 from the AI model definition database 430 and provided to the one or more node devices 105. The control routine 540 may include executable instructions operable on the processor(s) 550 to cause the processor(s) 550 to implement logic to perform various functions.

Similar to the tuning device 104, in embodiments in which the one or more node devices 105 include the one or more co-processors 555, the one or more co-processors 555 may similarly differ in processing architecture from the one or more processors 550 in a manner that is deemed to make the one or more co-processors 555 more amenable for use in implementing multiple instances of the AI model. More specifically, in some embodiments, each of the one or more co-processors 555 may be a GPU, a neuromorphic device, etc.

Referring to both FIGS. 4 and 5, execution of the control routine 440 by at least one of the one or more processors 450 may cause the processor(s) 450 to operate the network interface 490 to monitor for, and to receive, the request for the performance of tuning of the hyperparameters of the AI model, including the request data 234. Again, the request data 234 may specify the AI model, the hyperparameter search space, the starting point within that space, the data set 330 to be retrieved and used in testing sets of the hyperparameters, selections of generation and/or prediction model(s), and/or evaluation criteria. Following receipt of the request, the processor(s) 450 may retrieve the information needed to implement the AI model indicated in the request data 234 from the entry 431 that corresponds thereto in preparation for instantiating numerous instances of the AI model throughout multiple iterations of the tuning of its hyperparameters.

As previously discussed, in some embodiments, it may be the processing and/or storage resources of the tuning device 104 that are used in performing the iterations of tuning of the hyperparameters of the AI model, including the generating and/or testing of sets of hyperparameters, and/or the evaluation of the results of such testing. In such embodiments, the processor(s) 450 may operate the network interface 490 to retrieve the data set 330 identified in the request data 234 from the one or more data devices 103.

With the data set 330 and the information needed to implement the AI model retrieved, the processor(s) 450 may then generate one or more sets of hyperparameters for the AI model, and then instantiate a separate instance of the AI model based on and for each of those sets of hyperparameters. More specifically, it may be that the processor(s) 450 generate a “batch” of a predetermined quantity of sets of hyperparameters at a time, and instantiate a corresponding batch of instances of the AI model in which each instance of the AI model is based on a different one of the sets of hyperparameters in the batch of sets of hyperparameters. It may be that the processor(s) 450 are caused to configure and use the one or more co-processor(s) 455 in so instantiating each instance of the AI model in embodiments in which the tuning device 104 includes the one or more co-processors 455.

The processor(s) 450 may then employ a portion of the data set 330 that is designated as the training data to train each instance of the AI model. Following such training, the processor(s) 450 may then employ another portion of the data set 330 that is designated as the testing data to test each of the now trained instances of the AI model. Following such testing, the processor(s) 450 may use the evaluation criteria conveyed in the request data 234 to evaluate the results of the testing of each instance of the AI model. As previously discussed, in some embodiments, the evaluation of results of testing each instance of the AI model may entail evaluating the outputs of the instance of the AI model, directly. However, as also previously discussed, in other embodiments, the evaluation of the results of test each instance of the AI model may entail evaluating the output(s) of a post-AI function that generates its output(s) from the outputs of the instance of the AI model.

However, as also previously discussed, in other embodiments, it may the processing and/or storage resources of the one or more node devices 105 that are used in performing the iterations of tuning of the hyperparameters of the AI model, including testing of sets of hyperparameters of the AI model, and/or the evaluation of the results of such testing. In such other embodiments, the processor(s) 450 of the tuning device 104 may, initially, operate the network interface 490 to distribute the retrieved information from the entry 431 that corresponds to the AI model and/or from the request data 234 among the one or more node devices 105. Within each of the one or more node devices 105, execution of the control routine 540 may cause the processor(s) 550 to use the identifier of the data set 330 relayed thereto from the tuning device 104 to operate the network interface 590 to so retrieve the data set 330 from the one or more data devices 103.

The processor(s) 450 of the tuning device 104 may still generate the batches of sets of hyperparameters, and may then operate the network interface 490 to distribute individual sets of hyperparameters from each such batch or to distribute whole batches of sets of hyperparameters to each of the one or more node devices 105 via the network 109 to thereby enable the one or more node devices 105 to instantiate one or more corresponding instances of the AI model or to instantiate one or more corresponding batches of instances of the AI model at least partially in parallel. Within each of the one or more node devices 105, the processor(s) 550 of each may so instantiate one or more instances or batches of instances of the AI model, each based on a different set of hyperparameters received from the tuning device 104.

Within each of the one or more node devices 105, the processor(s) 550 may then employ a portion of the data set 330 that is designated as the training data to train each instance of the AI model. Following such training, the processor(s) 550 may then employ another portion of the data set 330 that is designated as the testing data to test each of the now trained instances of the AI model. Following such testing, the processor(s) 550 may use the evaluation criteria relayed to the one or more node devices 105 from the tuning device 104 to evaluate the results of the testing of each instance of the AI model. The processor(s) 550 of each of the one or more node devices 105 may then operate the network interface 590 thereof to transmit an indication of the results of the testing and/or of the evaluation(s) thereof to the tuning device 104.

As previously discussed, the one or more prediction models to be used in evaluating the efficacy of the testing of particular sets of hyperparameters and/or of continuing the tuning of hyperparameters may, initially, be operated in a training mode during an initial quantity of iterations of the tuning of hyperparameters of the AI model. During such a training mode, sets of hyperparameters for instances of the AI model and their corresponding evaluations of the results of the testing thereof may be employed as training data to train the one or more prediction models. Such a training mode may continue for a predetermined period of time and/or through a predetermined number of iterations of the performance of the tuning of hyperparameters of the AI model.

Following completion of such a training mode, the one or more prediction models may then be operated in a prediction mode during which the one or more prediction models may be used to make, for each set of hyperparameters of each batch of hyperparameters, a prediction of whether the set of hyperparameters will likely be found through testing to improve the tuning of hyperparameters for the AI model so as to come closer to achieving a threshold specified in the evaluation criteria such that it may be deemed efficacious to proceed with using the time, as well as processing and/or storage resources to perform such testing of that set of hyperparameters. Such use of the one or more prediction models seeks to at least reduce the number of instances in which such resources are expended on testing sets of hyperparameters that are deemed unlikely to lead to any improvement in the tuning of hyperparameters for the AI model.

As will be explained in greater detail, various situations arising from the combination of evaluating testing results and/or of evaluating the accuracy of the predictions made by the one or more prediction models may lead to the cessation of the tuning of hyperparameters of the AI model with either success in such tuning, or a determination that success in such tuning is not possible such that the further performance of such tuning is not deemed to be efficacious.

Alternatively or additionally, and as also previously discussed, the one or more generation models to be used in refining the generation of sets of hyperparameters may be trained based at least on the results of actual testing of instances of the AI model. However, as has also been discussed, the training of the one or more generation models may also be based on the predictions made using the one or more prediction models, although such training based on predictions may be conditioned on the degree of accuracy of the prediction models having achieved a predetermined threshold. As will also be explained in greater detail, various situations arising from the progressive reduction of the hyperparameter search space may lead to the cessation of the tuning of hyperparameters of the AI model.

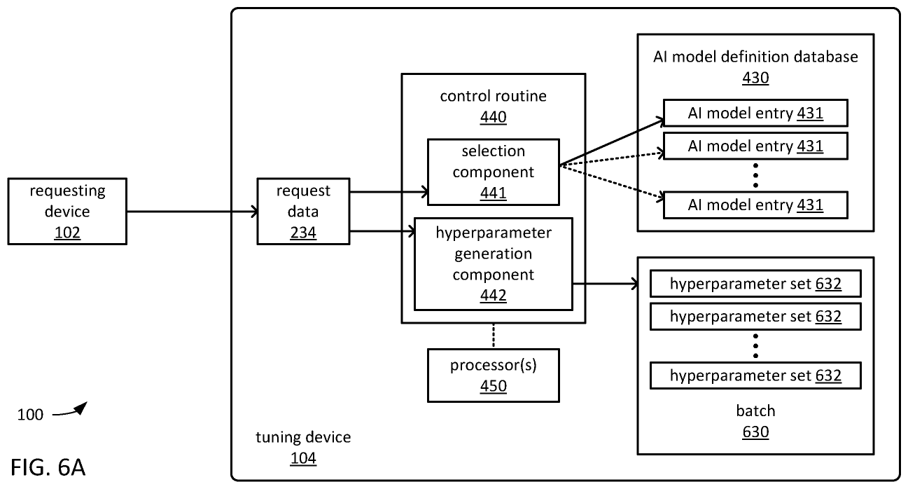

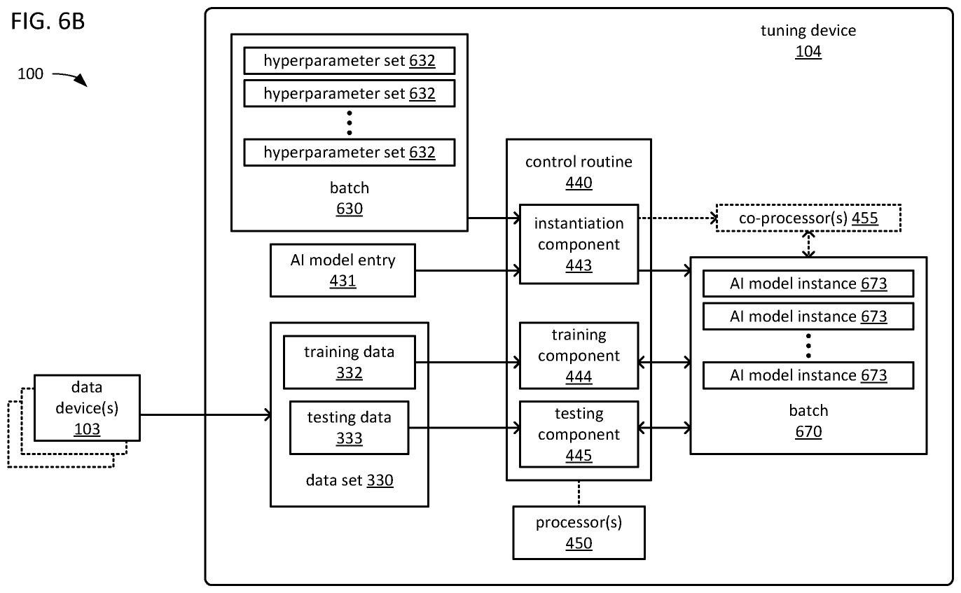

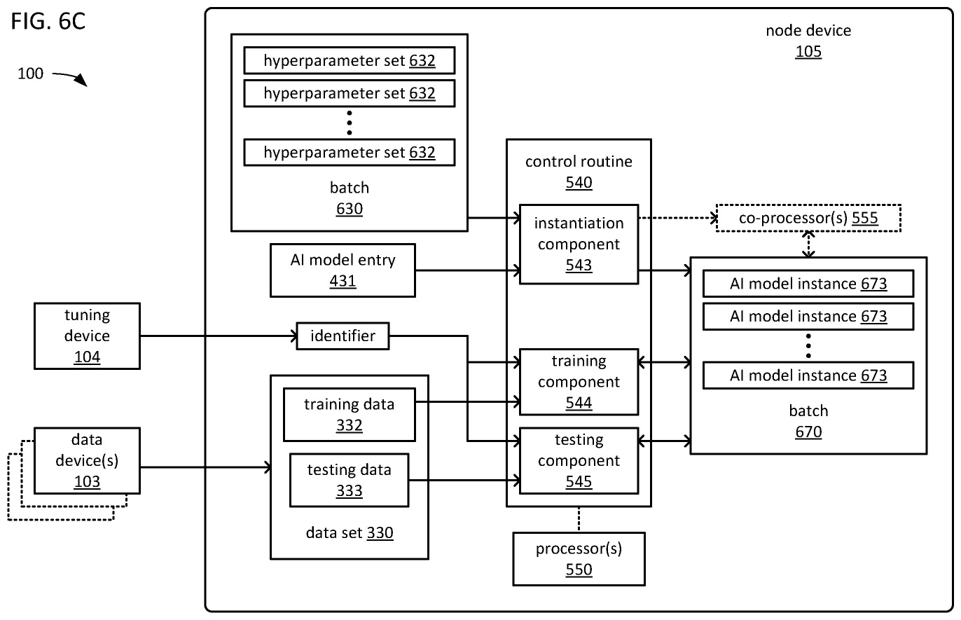

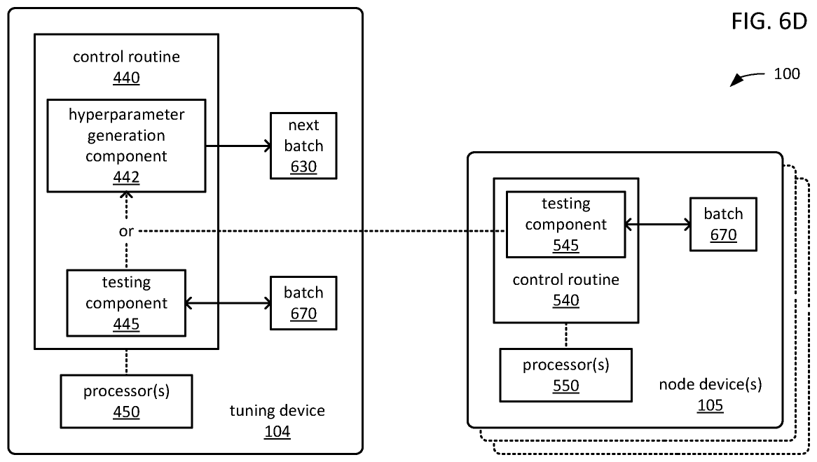

FIGS. 6A through 6D, taken together, illustrate an exemplary performance of tuning of hyperparameters of an AI model. FIG. 6A illustrates an example of preparations to perform iterations of tuning the hyperparameters. FIG. 6B illustrates an example of a performance of iterations of tuning the hyperparameters using processing and/or storage resources of an example of the tuning device 104. FIG. 6C illustrates an example of a performance of iterations of tuning the hyperparameters using processing and/or storage resources of an example one of the one or more node devices 105. FIG. 6D illustrates an example of employing the results of earlier iterations in generating more sets of hyperparameters for further iterations.

As shown in FIG. 6A, the control routine 440 may include a selection component 441 and/or a hyperparameter generation component 442, which may each be executed to implement logic to perform various operations as a result of execution of the control routine 440. In being so executed, the selection component 441 may operate the network interface 490 to monitor for, and to receive, a request for the performance of tuning of the hyperparameters of an AI model identified in the request data 234 that may be received as part of the request. The request data 234 may also specify the hyperparameter search space, the starting point within that space, and/or the data set 330 to be retrieved and used in the testing of sets of the hyperparameters. The selection component 441 may then retrieve the information needed to implement the AI model from the entry 431 that corresponds to the AI model. In also being executed, the hyperparameter generation component 442 may use the received indications of the hyperparameter search space and/or of the of the starting point within that search space as a basis for generating at least one batch 630 of multiple sets 632 of hyperparameters.

As shown in FIG. 6B, in at least embodiments in which the processing and/or storage resources of the tuning device 104 are used in performing the iterations of tuning of hyperparameters of the AI model, the control routine 440 may also include an instantiation component 443, a training component 444 and/or a testing component 445, which may each be executed to implement logic to perform various operations as a result of execution of the control routine 440. In being so executed, the instantiation component 443 may instantiate at least one batch 670 of instances 673 of the AI model in which each instance 673 of the AI model is based on a different one of the sets 632 of hyperparameters in the at least one batch 630 of sets 632 of hyperparameters. Following the instantiation of the at least one batch 670, the training component 444 may employ a portion of the data set 330 that is designated as the training data to train each of the instances 673 of the AI model. Following such training, the testing component 445 may employ another portion of the data set 330 that is designated as the testing data to test each of the now trained instances 673 of the AI model.

As shown in FIG. 6C, in at least embodiments in which the processing and/or storage resources of the one or more node devices 105 are used in performing the iterations of tuning of hyperparameters of the AI model, the control routine 540 may include an instantiation component 543, a training component 544 and/or a testing component 545, which may each be executed to implement logic to perform various operations as a result of execution of the control routine 540. As a comparison between the FIGS. 6B and 6C reveals, the components 443, 444 and 445 of the control routine 440 perform substantially similar functions as the components 543, 544 and 545 of control routine 540. In being so executed, the instantiation component 543 may instantiate at least one batch 670 of instances 673 of the AI model in which each instance 673 of the AI model is based on a different one of the sets 632 of hyperparameters in the at least one batch 630 of sets 632 of hyperparameters. Following the instantiation of the at least one batch 670, the training component 544 may employ a portion of the data set 330 that is designated as the training data to train each of the instances of instance 673 of the AI model. Following such training, the testing component 545 may employ another portion of the data set 330 that is designated as the testing data to test each of the now trained instances 673 of the AI model. The testing component 545 may then transmit an indication of the results to the tuning device 104.

Turning to FIG. 6D, regardless of whether the processing and/or storage resources of the tuning device 104 are used to perform the tuning of hyperparameters of the AI model, or the processing and/or storage resources of the one or more node devices 105 are so used, following the testing of the batch 670 of instances 673 of the AI model by either of the testing components 445 or 545, the hyperparameter generation component 442 may employ indications of the results of such testing to guide its generation of a next batch 630 of sets 632 of hyperparameters. As previously discussed, any of a wide variety of techniques for the generation of sets 632 of hyperparameters may be used, including and not limited to, at least some degree of pseudo-random generation of hyperparameter values. However, it is envisioned that the technique selected for use may, alternatively or additionally, employ the results of testing previously generated sets of hyperparameters in an effort to enable the achievement of some degree of improvement as ever newer batches 630 of sets 632 of hyperparameters are generated.

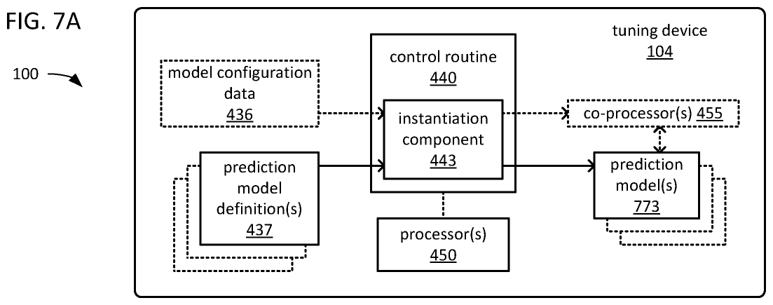

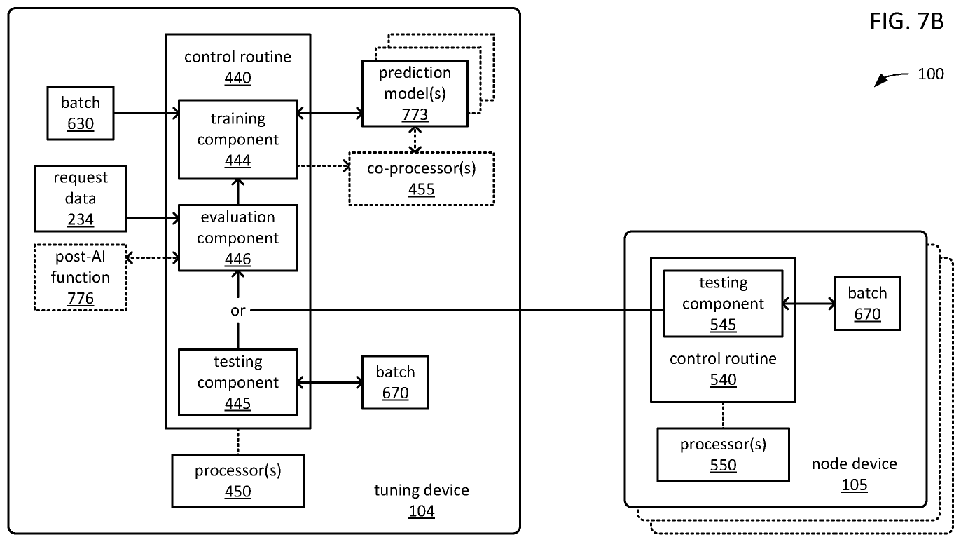

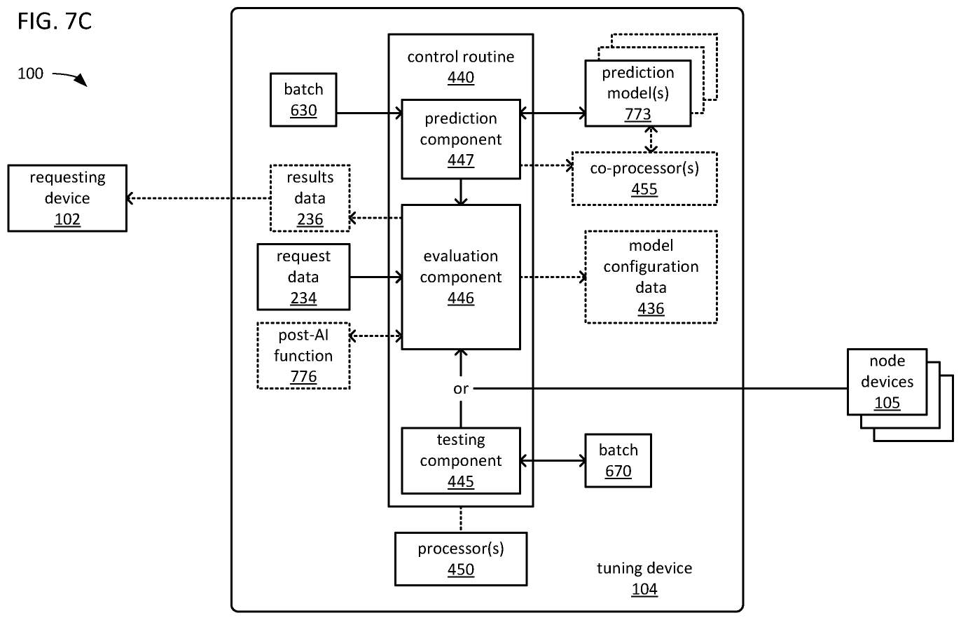

FIGS. 7A through 7C, taken together, illustrate an exemplary use of machine learning to control the performance of tuning of hyperparameters of FIGS. 6A-D. FIG. 7A illustrates an example of preparations for the training and use of one or more prediction models 773. FIG. 7B illustrates an example of training the one or more prediction models 773 during the performance of initial iterations of tuning hyperparameters. FIG. 7C illustrates an example of using the one or more prediction models 773 to control the performance of subsequent iterations of tuning hyperparameters.

Turning to FIG. 7A, the instantiation component 443 may instantiate the one or more prediction models 773. Again, like the AI model, each of the prediction models 773 may be based on any of a wide variety of types of machine learning model. More specifically, each prediction model 773 of the one or more prediction models 773 may be based on a separate one of the prediction model definitions 437, which may each specify a different corresponding type of machine learning model.

As shown in FIG. 7B, the control routine 440 may also include an evaluation component 446. Following the testing of each of the instances 673 of the AI model of a batch 670 by the testing component 445 in FIG. 6B or by the testing component 545 in FIG. 6C, the evaluation component 446 may employ the evaluation criteria indicated in the request data 234 to evaluate the results of such testing.

As previously discussed, the one or more prediction models 773 may, initially, be operated in a training mode during the performance of an initial quantity of iterations of the tuning of hyperparameters of the AI model. During such a training mode, the sets 632 of hyperparameters and the corresponding evaluations of the results of the testing of the corresponding instances 673 of the AI model may be employed as training data to train the one or more prediction models 773. Such a training mode may continue for a predetermined period of time and/or through a predetermined number of iterations of the performance of the tuning of hyperparameters of the AI model (e.g., through a predetermined number of batches 630 of sets 632 of hyperparameters).

However, and referring to both FIGS. 7A and 7B, where there is an opportunity to employ transfer learning to obtain the benefit of earlier training of each prediction model of the one or more prediction models 773 from a training mode of a previous effort at hyperparameter tuning, then such transfer learning may be employed to obviate the need to again place the one or more prediction models 773 in a training mode, thereby allowing the one or more prediction models 773 to be immediately put to use in prediction mode. More specifically, if there has been a previous use of each prediction model of the one or more prediction models 773 in earlier iterations of an earlier performance of hyperparameter tuning for the same AI model and/or with the same data set 330, and if the predictions generated during those earlier iterations of that earlier performance were deemed sufficiently accurate (e.g., meeting a predetermined minimum threshold of degree of accuracy), and if a model configuration data 436 was generated that captures and includes a representation of the training of the one or more prediction models 773, then the instantiation component 443 may retrieve that model configuration data 436, and may use the training that it represents to instantiate the one or more prediction models 773 with the benefit of the training from that earlier performance of hyperparameter tuning through transfer learning.

As shown in FIG. 7C, the control routine 440 may also include a prediction component 447. Following completion of the training mode (or following the instantiation of the one or more prediction models 773 with the benefit of earlier training via transferred learning), the one or more prediction models 773 may then be operated in a prediction mode during which the one or more prediction models 773 may be used to make a prediction of whether each set 632 of hyperparameters within each batch 630 will likely be found (through the testing described as performed in either of FIGS. 6B or 6C) to improve the tuning of hyperparameters for the AI model so as to come closer to achieving a threshold specified in the evaluation criteria such that it may be deemed efficacious to actually perform the testing of the set 632 of hyperparameters. Again, such use of the one or more prediction models 773 seeks to reduce instances in which time, as well as processing and/or storage resources, are expended on testing sets 632 of hyperparameters that are deemed unlikely to lead to any improvement in the tuning of hyperparameters for the AI model.

In some embodiments, the evaluation component 446 may use such predictions, along with the evaluations of the results of testing sets 632 of hyperparameters that were deemed efficacious to test, as inputs to determining whether or not the evaluation criteria have been met such that the performance of tuning of hyperparameters of the AI model has been successful, and/or as inputs to determining whether or not the performance of further iterations of the tuning of hyperparameters of the AI model are likely to result in further improvement in the tuning of the hyperparameters. Where the performance of such tuning is determined to have been successful, the evaluation component 446 may cause a cessation of further iterations of the performance, and transmit to the requesting device 102 the results data 236 with an indication of success and/or the set of hyperparameters derived through such tuning.

In such embodiments, and where the performance of such tuning is determined to have been successful, and where the one or more prediction models 773 have been deemed to have made predictions with sufficient accuracy, the model configuration data 436 may be generated by the evaluation component 446 to preserve the results of such successful training of the one ore more prediction models 773 to enable transfer learning to be used for the benefit of a future performance of hyperparameter tuning for the same AI model, with the same data set 330 and/or with the same prediction model(s) 773. It should be noted that such generation of the model configuration data 436 may occur only if the model configuration data 436 does not already exist, and was not used in instantiating the one or more prediction models 773 without any additional training following such instantiation.

Alternatively or additionally, where it is determined that further iterations of performance of such tuning are unlikely to result in the successful derivation of a tuned set of hyperparameters (or in other words, it is determined to be unlikely that the hyperparameters will converge to a location within the hyperparameter search space that results in the evaluation criteria being met), the evaluation component 446 may cause a cessation of further iterations of the performance, and transmit to the requesting device 102 the results data 236 with an indication of cessation with a prediction of there being no likelihood of success. In some embodiments, a lack of accuracy meeting a predetermined threshold for the predictions using the one or more prediction models 773 may serve as another basis for the evaluation component 446 to cause such a cessation of further iterations due to there being no likelihood of success. Such a lack of accuracy of the predictions may be taken as an indication that a convergence of the hyperparameters to a single location within the hyperparameter search space is unlikely to occur, as it should otherwise be possible to achieve better accuracy.

Again, as previously discussed, in some embodiments, the evaluation of results of testing each instance 673 of the AI model may entail evaluating the outputs of the instance 673 of the AI model, directly. However, as also previously discussed, in other embodiments, the evaluation of the results of testing each instance 673 of the AI model may entail evaluating the output(s) of a post-AI function 776 that generates its output(s) from the outputs of the instance 673 of the AI model.

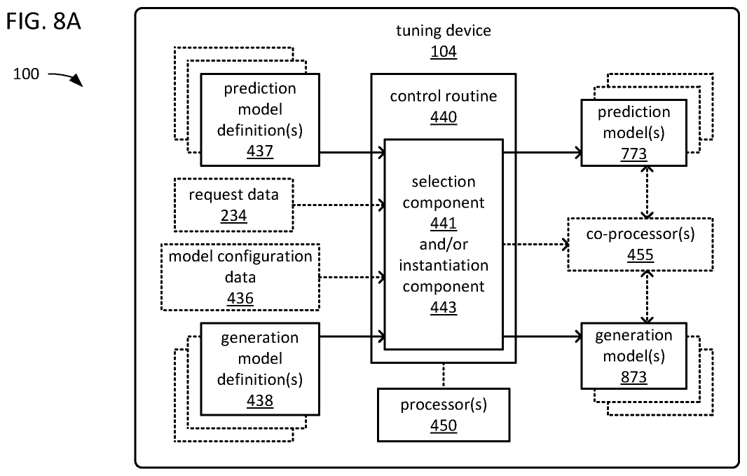

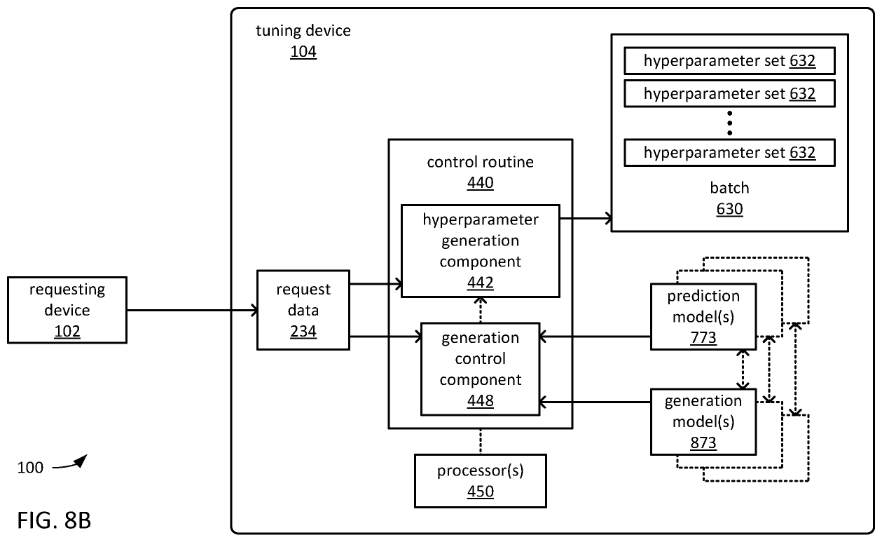

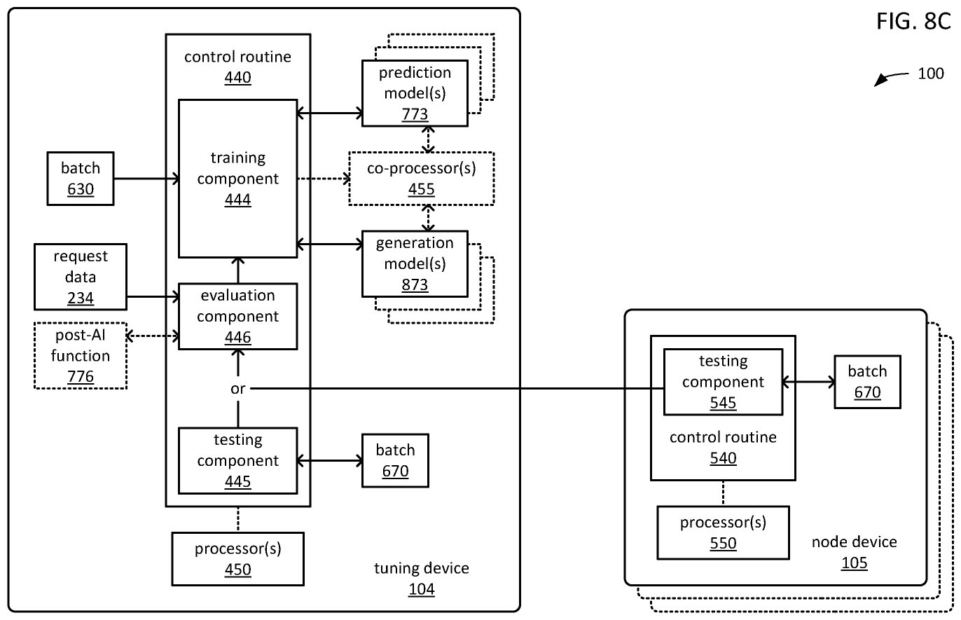

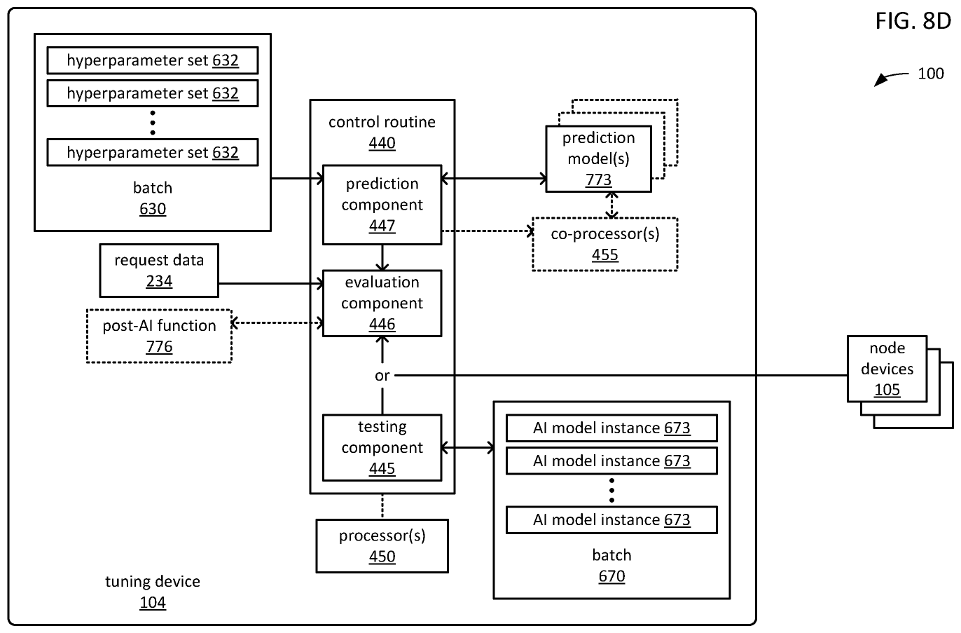

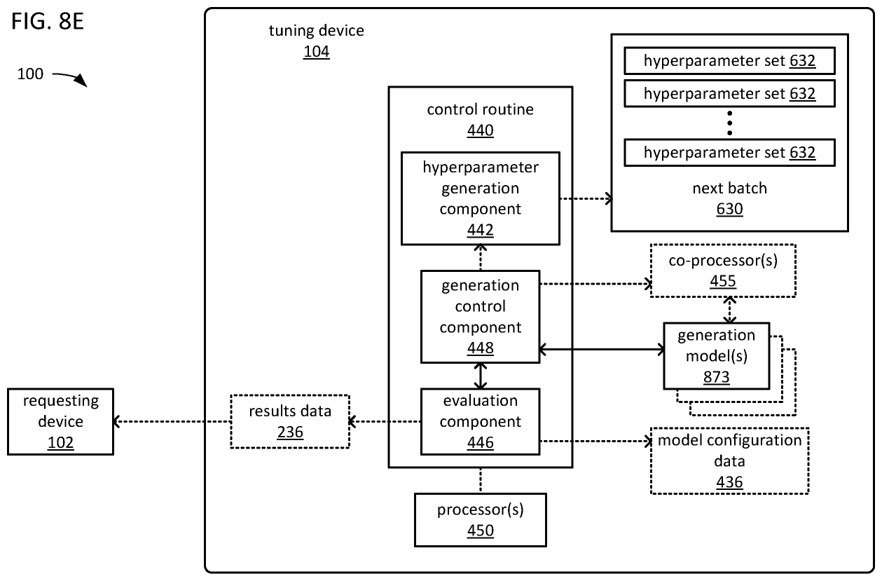

FIGS. 8A through 8E, taken together, illustrate another exemplary use of machine learning to control the performance of tuning of hyperparameters of FIGS. 6A-D. FIG. 8A illustrates an example of preparations for the training and use of one or more prediction models 773 and/or one or more generation models 873. FIG. 8B illustrates an example of preparations to perform iterations of tuning hyperparameters using the one or more generation models 873. FIG. 8C illustrates an example of training the one or more prediction models 773 and/or the one or more generation models 873 during the performance of at least initial iterations of tuning hyperparameters. FIG. 8D illustrates an example of using the one or more prediction models 773 as an input to controlling the performance of at least subsequent iterations of tuning hyperparameters. FIG. 8E illustrates an example of using the one or more generation models 873 as an input to controlling the performance of subsequent iterations of tuning hyperparameters.

Turning to FIG. 8A, the instantiation component 443 may instantiate the one or more generation models 873 in addition to, or in lieu of, instantiating the one or more prediction models 773. Again, like the AI model and each of the prediction models 773, each of the generation models 873 may be based on any of a wide variety of types of machine learning model. More specifically, each generation model 873 of the one or more generation models 873 may be based on a separate one of the generation model definitions 438, which may each specify a different corresponding type of machine learning model.

As previously discussed, in some embodiments, it may be that the request data 234 may specify one or both of which prediction model(s) 773 and/or which generation model(s) 883 are to be used in tuning the hyperparameters of the AI model. In such embodiments, instantiation of the prediction model(s) 773 and/or of the generation model(s) 883 by the instantiation component 443 may be preceded by the retrieval of appropriate ones of the prediction model definition(s) 437 and/or of the generation model definition(s) 438, respectively, by the selection component 441.

As shown in FIG. 8B, the control routine 440 may include a generation control component 448, which may be executed to implement logic to perform various operations as a result of execution of the control routine 440. As previously discussed, in being executed, the hyperparameter generation component 442 may use the specification provided in the request data 234 of the hyperparameter search space and/or of the of the starting point within the hyperparameter search space as a basis for generating at least one batch 630 of multiple sets 632 of hyperparameters. However, in also being executed, the generation control component 448 may use those same specifications provided in the request data 234 as a basis for controlling the generation of each set 632 of hyperparameters by the hyperparameter generation component 442, and may do so to aid in the training of the of one or more prediction models 773 during the training period, and/or to aid in progressively refining the generation of sets 632 of hyperparameters to reduce the consumption of time, and/or of other resources in tuning hyperparameters.

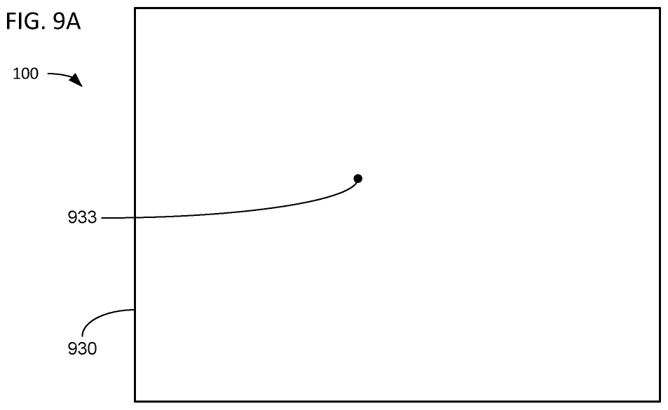

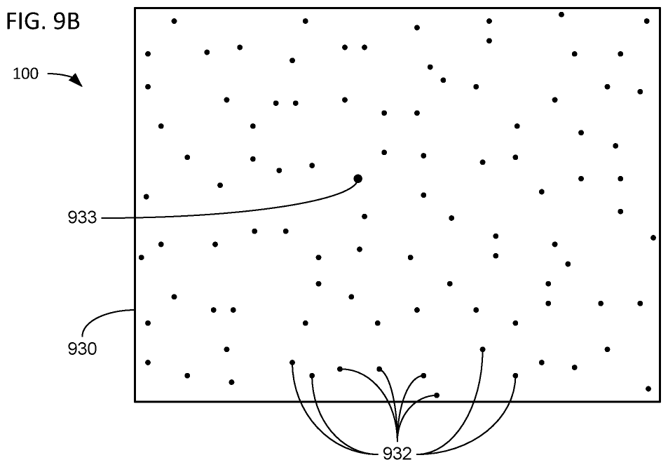

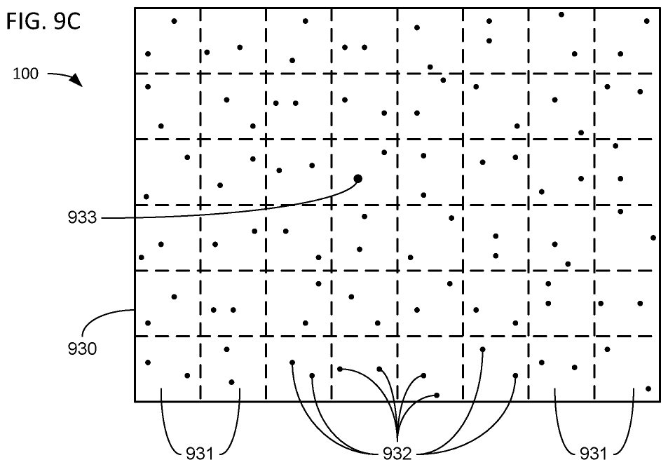

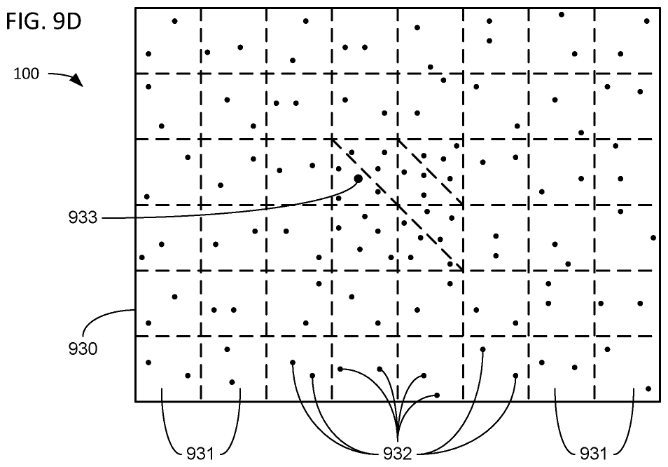

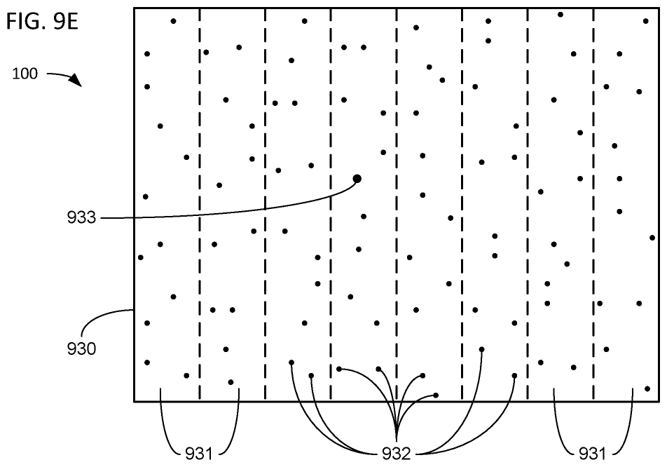

By way of example, and turning briefly to FIG. 9A, the request data 234 may specify a hyperparameter search space 930 using a specified range of values for each hyperparameter, using a set of mathematical expressions describing mathematical relations among hyperparameters, and/or using any of a variety of other approaches to defining the hyperparameter search space 930. As previously discussed, the request data 234 may also specify a single initial set of hyperparameters that define a starting point 933 within the hyperparameter search space 930 for the tuning of hyperparameters. It should be noted that the particular example hyperparameter search space 930 depicted in FIGS. 9A through 9F is a deliberately highly simplified example of a hyperparameter search space capable of being depicted (along with the starting point 933) as a two-dimensional space to aid in understanding the discussion herein, and it should be understood that this deliberate simplicity should not be taken as limiting. More specifically, it should be understood that it is envisioned that the techniques described herein for hyperparameter tuning will likely be applied to considerably more complex sets of hyperparameters that are to be generated from hyperparameter search spaces having a considerably more complex configuration such that presenting a two-dimensional visualization thereof (including a starting point therein) may be considerably more difficult.

Continuing with FIG. 8B, again, as previously discussed, the one or more prediction models 773 may initially be operated in a training mode during the performance of an initial quantity of iterations of the tuning of hyperparameters of the AI model. However, during such a training mode, the one or more generation models 873 may also be trained alongside the one or more prediction models 773 using the results of the testing of sets 632 of hyperparameters generated by the hyperparameter generation component 442 as the tuning of hyperparameters is at least begun, either by the testing component 445 in FIG. 6B or by the testing component 545 in FIG. 6C. Again, such a training mode may continue for a predetermined period of time and/or through a predetermined number of iterations of the performance of the tuning of hyperparameters of the AI model (e.g., through a predetermined number of batches 630 of sets 632 of hyperparameters).

As also previously discussed, it may be that, during such training mode(s), the hyperparameter generation component 442 is caused to aid in improving the training of the one or more prediction models 773, and/or the one or more generation models 873, by generating sets 632 of hyperparameters that include combinations of hyperparameter values that are widely distributed throughout the hyperparameter search space. By way of example and turning briefly to FIG. 9B, it may be that the generation control component 448 cooperates with the hyperparameter generation component 442 in a “dispersion mode” to select combinations of hyperparameter values (starting with the initial set of hyperparameters of the starting point 933) to become the sets 632 of the hyperparameters generated during the training mode that achieve a relatively even distribution throughout the example hyperparameter search space 930.

In some embodiments, various characteristics of the manner in which those sets 632 of hyperparameters are dispersed throughout the hyperparameter search space 930 may be at least partially dependent upon which prediction model(s) 773 are to be used in making predictions. By way of example, it may be that be known that a particular prediction model 773 is unlikely to be sufficiently trained unless a particular minimum quantity of sets 632 of hyperparameters are used in its training, and/or unless a particular minimum density of the coverage of the hyperparameter search space 930 with points represented by the sets 632 of hyperparameters is reached. Thus, the selection of one or more particular prediction models 773 may at least partially determine the length of time of the training mode and/or number of sets 632 of hyperparameters that must be generated for the training mode, and accordingly, the length of time and/or the number of sets 632 of hyperparameters that may be generated in such a dispersion mode by such cooperation between the hyperparameter generation component 442 and the generation control component 448.

Alternatively or additionally, it may be that the selection of one or more particular generation models 883 is similarly determinative of the length of time of the training mode and/or number of sets 632 of hyperparameters that must be generated for the training mode. More specifically, it may be that be known that a particular generation model 873 is unlikely to be sufficiently trained unless a particular minimum quantity of sets 632 of hyperparameters are used in its training, and/or unless a particular minimum density of the coverage of the hyperparameter search space 930 with points represented by the sets 632 of hyperparameters is reached. In some embodiments, it may be that such characteristics of at least a subset of the prediction models 773 and/or of at least a subset of the generation models 873 result in particular ones of the prediction models 773 and corresponding particular ones of the generation models 873 being associated with each other such that the selection of a particular prediction model 773 is caused to automatically beget the selection of a corresponding particular generation model 873, or vice versa.

Turing to FIG. 8C, at least during the training mode, as each of the instances 673 of the AI model of a batch 670 is tested by the testing component 445 as discussed in connection with FIG. 6B, or is tested by the testing component 545 as discussed in connection with FIG. 6C, the evaluation component 446 may employ the evaluation criteria specified in the request data 234 to evaluate the results of such testing, as previously discussed in connection with FIG. 7C. Again, in some embodiments, the evaluation of results of testing each instance 673 of the AI model may entail evaluating the outputs of the instance 673 of the AI model, directly. Alternatively, in other embodiments, the evaluation of the results of testing each instance 673 of the AI model may entail evaluating the output(s) of a post-AI function 776 that generates its output(s) from the outputs of each instance 673 of the AI model.

However, and referring to both FIGS. 8A and 8C, transfer learning may be employed as an alternative to such a training mode where there is an opportunity to obtain the benefit of earlier training of the one or more prediction models 773, and/or the one or more generation models 873 from a previous performance of hyperparameter tuning. More specifically, if there has been a previous use of the one or more prediction models 773, and/or a previous use of the one or more generation models 873 in earlier iterations of an earlier performance of hyperparameter tuning for the same AI model and/or with the same data set 330 that did end with a successful tuning of hyperparameters; and if a model configuration data 436 was generated that captures and includes a representation of the training of the one or more prediction models 773, and/or of the training of the one or more generation models 873; then the instantiation component 443 may retrieve that model configuration data 436, and may use the training that it represents to instantiate the one or more prediction models 773, and/or the one or more generation models 873 with the benefit of that earlier training.

Turning to FIG. 8D, regardless of whether the one or more prediction models 773 are trained during the training mode or are instantiated with the benefit of earlier training via transferred learning, in the prediction mode, the prediction component 447 may use the one or more prediction models 773 to make predictions concerning whether each subsequently generated set 632 of hyperparameters within each batch 630 will likely be found (through the testing described as performed in either of FIGS. 6B or 6C) to improve the tuning of hyperparameters for the AI model such that it may be deemed efficacious to devote the time and/or other resources to actually perform the testing of the set 632 of hyperparameters. Again, as previously discussed in connection with FIG. 7C, the evaluation component 446 may use such predictions, along with the evaluations of the results of actual testing of sets 632 of hyperparameters that were deemed efficacious to test, as inputs to determining whether or not the evaluation criteria have been met such that the performance of tuning of hyperparameters of the AI model has been successful, and/or as inputs to determining whether or not the performance of further iterations of the tuning of hyperparameters of the AI model are likely to result in further improvement in the tuning of the hyperparameters.

Referring to both FIGS. 8B and 8D, as previously discussed, during the performances of iterations of the tuning of hyperparameters of the AI model after either the training mode or the aforedescribed use of transfer learning, the generation control component 448 may cooperate with the hyperparameter generation component 442 in a “reduction mode” to generate sets 632 of the hyperparameters in a manner that covers the hyperparameter search space in a way that progressively removes more and more of the search space from further consideration. Stated differently, as an approach to refining the generation of sets 632 of hyperparameters, there may be a progressive reduction in the search space from which subsequent sets 632 of hyperparameters are generated to be at least considered for testing.

By way of example and turning briefly to FIG. 9C, the generation control component 448 may divide the hyperparameter search space 930 into multiple portions 931, such as the depicted grid of portions 931 in the highly-simplified example hyperparameter search space 930 of FIGS. 9A-F. Following such a division, and turning to FIG. 9D, the generation control component 448 may cooperate with the hyperparameter generation component 442 in the reduction mode to generate batches 630 of multiple sets 632 of hyperparameters where, within each such batch 630, all of the points represented by each of the sets 632 of hyperparameters therein exist within the same portion 631. The components 442 and 448 may cooperate to so generate such “homogenous” batches 630 in a manner that proceeds sequentially through one portion 931 of the hyperparameter search space 930 at a time in a manner that enables the sequential ruling out of individual portions 931 from which relatively few sets 632 of hyperparameters (or from which no sets 632 of hyperparameters) are observed to have been generated that were successful in furthering the tuning of the hyperparameters of the AI model. As depicted, such a sequential trial of points within individual portions 931 may begin with the portion 931 that includes the starting point 933, and may then progressively extend to other portions 931 at ever increasing distances from the starting point 933. Such a progression ever further away from the starting point 933 may continue until an evaluation by the evaluation component 446 as discussed in connection with FIG. 7C results in a determination of a successful tuning of hyperparameters as either having been achieved or being unlikely to be achievable. Alternatively or additionally, such a progression ever further away from the starting point 933 may continue until all of the portions 931 of the hyperparameter search space 930 have been sequentially selected and then ruled out.

In contrast to the generation of such homogenous batches 630 in which all of the sets 632 of hyperparameters represent points that exist within the same portion 931 in the reduction mode, the generation control component 448 may cooperate with the hyperparameter generation component 442 in the dispersion mode to generate batches 630 of multiple sets 632 of hyperparameters where, within each such batch 630, the points represented by the sets 632 of hyperparameters therein may span multiple ones of the portions 931. Thus, each batch 630 generated in the dispersion mode may be “heterogeneous” insofar as the points represented by the sets 632 of hyperparameters therein do not all exist within just a single portion 931.

In some embodiments where the set 632 of hyperparameters includes numerous hyperparameters, it may be the division of the corresponding hyperparameter search space entails dividing the range of values for a single one of the hyperparameters into multiple subranges that each correspond to a single portion 931 of the hyperparameter search space. By way of example, and turning briefly to FIG. 9E, in the highly simplified two-dimensional example hyperparameter search space 930, the longer of the two dimensions may be divided into subranges, thereby creating multiple slice-like portions 931. Such an approach may be employed where at least one of the hyperparameters has a finite set of possible values (rather than a continuous range of values) such that each value in the finite set of values may be caused to correspond to one of the portions into which the hyperparameter search space is divided. Alternatively or additionally, such an approach may be employed where at least one of the hyperparameters is specified as having a particularly large range of values in comparison to other(s) of the hyperparameters such that a greater quantity of such “slices” is able to be created by dividing the range of values of that hyperparameter into subranges versus dividing the range of values specified for any of the other(s) of the hyperparameters. Turning briefly to FIG. 9F, with the hyperparameter search space 930 so divided along one of the dimensions thereof, the resulting portions 931 may be sequentially selected and removed from consideration, starting with the portion 931 that includes the starting point, as previously discussed in a reduction mode.

Again, it should be noted that the particular example hyperparameter search space 930 depicted in FIGS. 9A through 9F is a deliberately highly simplified example of a hyperparameter search space capable of being depicted (along with the starting point 933) as a two-dimensional space to aid in understanding the discussion herein, and it should be understood that this deliberate simplicity should not be taken as limiting. Accordingly, the depiction in FIGS. 9C and 9D of the division of this example hyperparameter search space 930 into a two-dimensional grid of portions 931 is also deliberately highly simplified. It is envisioned that dividing the more complexly configured hyperparameter search spaces that are envisioned to be used with the techniques described herein may also be considerably more complex.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. In addition, the given logic flow may be implemented by a hardware element, a software element executed by a processor, or any combination thereof. The embodiments are not limited in this context.

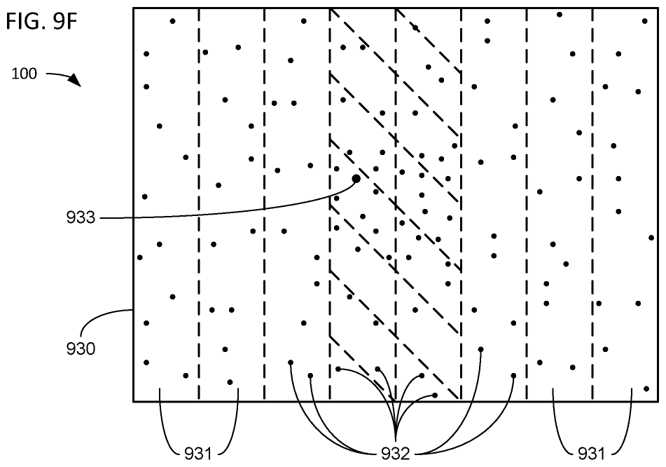

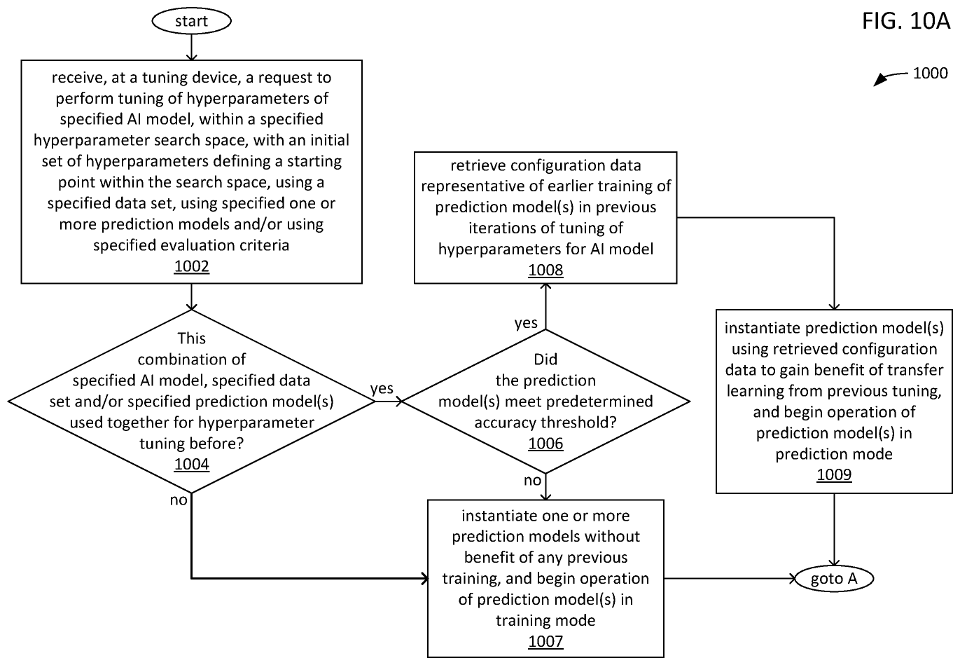

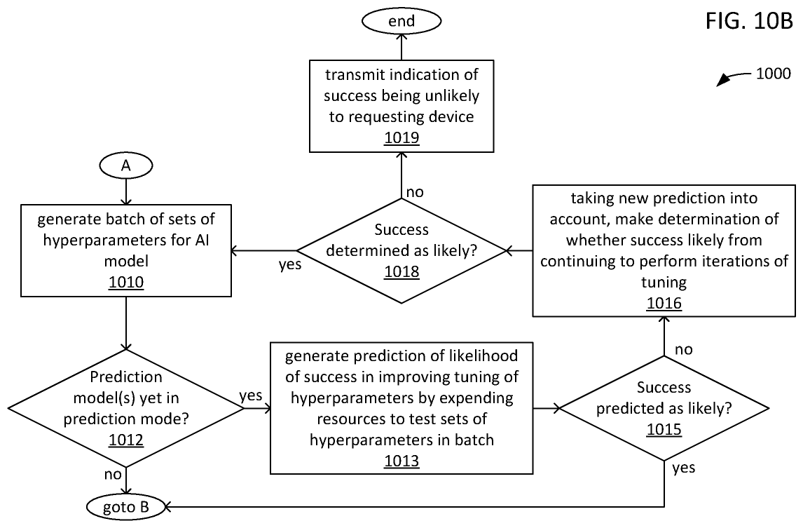

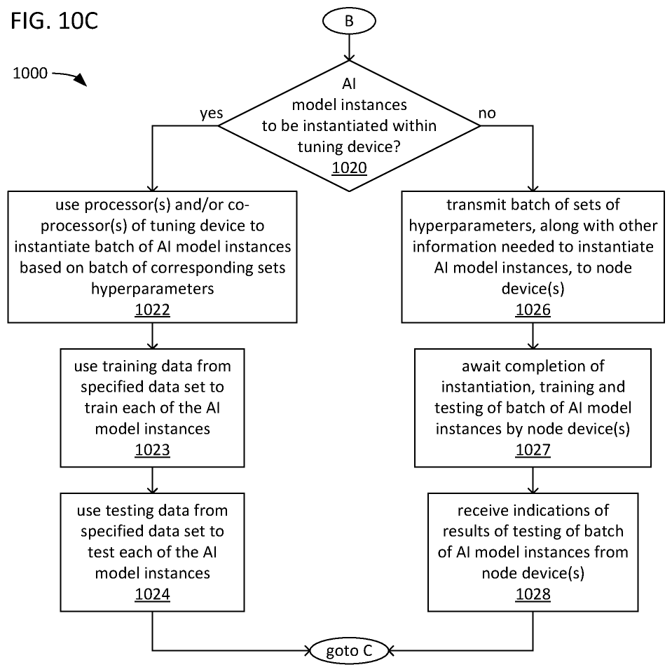

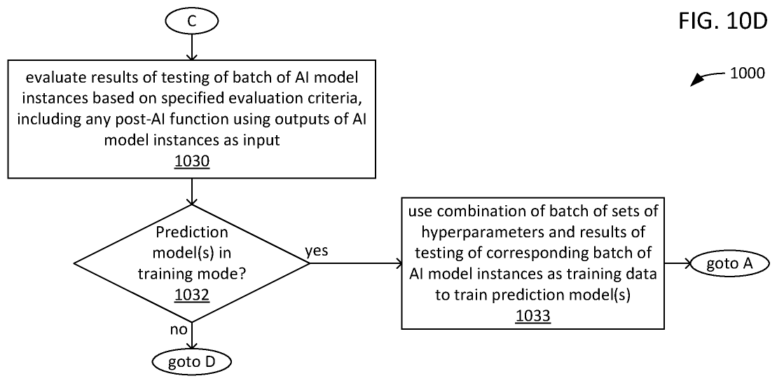

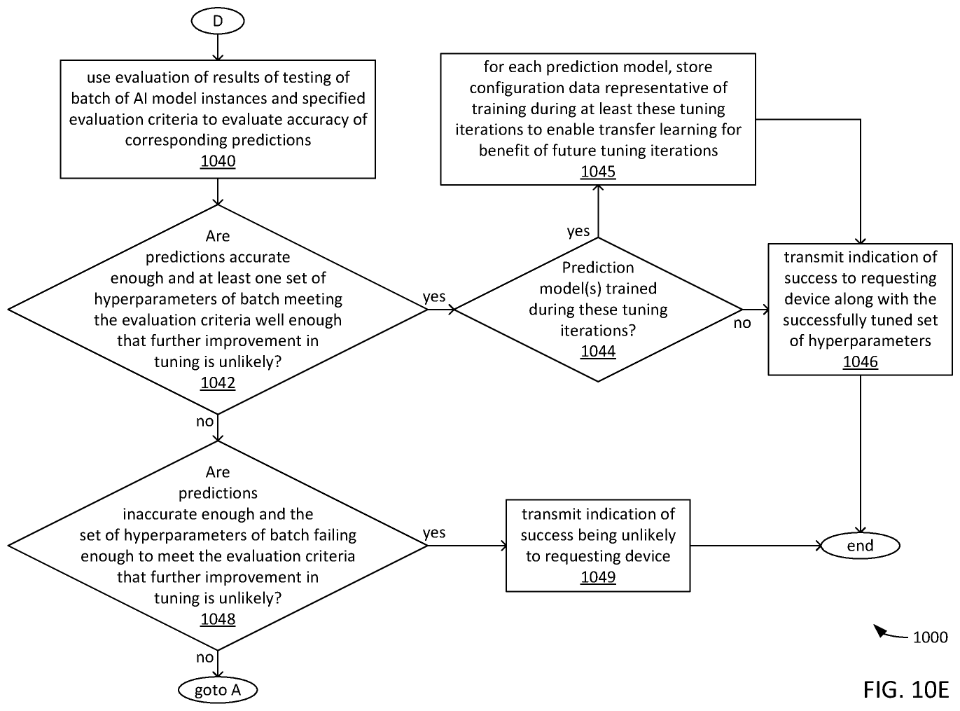

FIGS. 10A through 10E, taken together, illustrate an embodiment of a logic flow 1000. The logic flow 1000 may be representative of some or all of the operations executed by one or more embodiments described herein. For example, the logic flow 1000 may include some or all of the operations performed to tune hyperparameters of an AI model. However, embodiments are not limited in this context.

At 1002, a processor of a tuning device of a system may receive a request to perform a tuning of the hyperparameters of an AI model from a requesting device. The request may including information specifying the type and/or other aspects of the AI model, the boundaries of the hyperparameter search space to which the tuning of the hyperparameters is to be limited, an initial set of hyperparameters that define a starting point within the hyperparameter search space at which the tuning is to begin, an identifier of a data set from which training data and/or testing data is to be provided for use in the performance of tuning, the one or more prediction models to be used in making predictions concerning the efficacy of further iterations of tuning, and/or evaluation criteria by which aspects of the success of the performance and/or the efficacy of continuing with the performance may be determined.

At 1004, if the particular combination of the specified type of AI model, specified data set and/or specified one or more prediction models has not been used together, before, in tuning hyperparameters for the specified type of AI model, then at 1007, the processor may instantiate the one or more prediction models that are to be used in controlling the performance of iterations of the tuning. Upon being so instantiated, the one or more prediction models may be placed by the processor into a training mode, during which the one or more prediction models may be trained in preparation for being used to make predictions. As previously discussed, any of a variety of criteria may be used to trigger the transition of the one or more prediction models from the training mode and into a prediction mode in which the one or more prediction models are used to generate predictions concerning the efficacy of performances of iterations of the tuning of the hyperparameters. Such criteria may include, and is not limited to, a predetermined quantity of training data used to train the one or more prediction models, the passage of a predetermined amount of time since the performance of the tuning of hyperparameters commenced, etc. Thus, the transition from training mode to prediction mode may occur at any point throughout the logic flow 1000.

However, if at 1004, the particular combination of the specified type of AI model, specified data set and/or specified one or more prediction models has been used together, before, in previous iterations of performance of tuning hyperparameters for the specified type of AI model, then at 806, the processor may check whether the predictions made by the one or more prediction models in that previous use were sufficiently accurate as to meet a predetermined threshold of accuracy for such predictions. If not, at 1006, then the processor may proceed with instantiating the one or more prediction models at 1007 without the benefit of any transfer to the one or more prediction models of any training that may have occurred during that previous use.

However, if at 1006, the predictions made by the one or more prediction models in that previous use were sufficiently accurate, then at 1008, the processor may retrieve configuration data that is representative of what was learned by the one or more prediction models during that previous use to gain the benefit of that earlier training through transfer learning. At 1009, the processor may then use that configuration data to instantiate the one or more prediction models with the benefit of their training from that previous use. Upon being so instantiated, the one or more prediction models may be placed by the processor into the prediction mode.

At 1010, the processor may employ any of a wide variety of hyperparameter generation techniques to generate a batch of hyperparameters for the AI model within the boundaries of the hyperparameter search space, and using the initial set of hyperparameters as the starting point therein.

At 1012, if the one or more prediction models are in the prediction mode, then the processor, at 1013, may use the one or more prediction models to make predictions concerning the efficacy of expending time, as well as processing and/or storage resources to test the multiple sets of hyperparameters in the batch just generated at 1010. More precisely, predictions may be made of whether such an expenditure of time and/or other resources is likely to beget test results that will indicate that at least one of the sets of hyperparameters within the batch is successfully an improvement over previous sets of hyperparameters that have been tested such that the evaluation criteria for successfully deriving a set of hyperparameters is at least closer to being met such that an improvement in the tuning of hyperparameters of the AI model has been successfully made.

At 1015, if such success is not predicted to be likely, then the processor may make a determination at 1016 of whether success in further improving the tuning of the set of hyperparameters is likely from continuing to perform further iterations of the tuning. If, at 1018, such success is determined to be likely, then the processor may generate another batch of sets of hyperparameters at 1010. However, if at 1018, such success is determined to be unlikely, then the processor may transmit an indication of success in the tuning of the hyperparameters being unlikely to the requesting device at 1019.

However, if the prediction models are still in the training mode at 1012, or if success in improving the tuning of hyperparameters of the AI model from testing the batch of sets of hyperparameters is predicted to be likely at 1015, then the processor may make a check at 1020 of whether instances of the AI model are to be generated using resources of the tuning device. If resources of the tuning device are to be so used, then at 1022, one or more processors and/or co-processors of the tuning device may be used to instantiate a batch of instances of the AI model in which each instance within that batch corresponds to one of the sets of hyperparameters in the batch of sets of hyperparameters. At 1023, the one or more processors and/or co-processors of the tuning device may then use a training data taken from the specified data set to train each of the instances of the AI model. At 1024, the one or more processor and/or co-processors of the tuning device may use testing data taken from the specified data set to test each of the instances of the AI model, and in so doing, effectively test each of the sets of hyperparameters within the batch of sets of hyperparameters.

However, if at 1020, such resources of the tuning device are not to be so used, then at 1026, the processor of the tuning device may transmit the batch of sets of hyperparameters to one or more node devices, along with other information needed to instantiate the corresponding batch of instances of the AI model. At 1027, the processor of the tuning device may await the completion of such instantiation of the batch of instances of the AI model, as well as the training and testing thereof, by the one or more node devices. At 1028, the processor of the tuning device may receive indications of the results of such testing of the batch of instances of the AI model from the one or more node devices.

At 1030, regardless of whether resources of the tuning device or of one or more node devices were used to instantiate, train and test the batch of instances of the AI model, the processor of the tuning device may employ the specified evaluation criteria to evaluate the results of such testing. As has been discussed, in some embodiments, such an evaluation of testing may entail evaluating the outputs of each of the instances of the AI model, directly, while in other embodiments, such an evaluation of testing may entail evaluating an output of a post-AI function that accepts the outputs of an instance of the AI model as its inputs.

At 1032, if the one or more prediction models are in training mode, then the processor may use the combination of the batch of sets of hyperparameters and the results of the evaluation of the testing of the corresponding batch of instances of the AI model as training data to train the one or more prediction models at 1033. The processor may then proceed to generate another batch of sets of hyperparameters at 1010.

However, if at 1032, the one or more prediction models are in the prediction mode, then at 1040, the processor may use the evaluation of the results of the testing of the batch of instances of the AI model along with the specified evaluation criteria to evaluate the accuracy of the corresponding predictions that were made prior to the instantiation, training and testing of that batch of instances. If at 1042, the processor determines that the predictions were accurate enough (based on the evaluation criteria), and that at least one of the sets of hyperparameters within that batch thereof meets the evaluation criteria well enough that further improvement through further iterations of the performance of tuning of hyperparameters is deemed to be unlikely, then at 1044, the processor may check whether the one or more prediction models were trained during these iterations of tuning of hyperparameters for the AI model in response to received request. If not, then at 1046, the processor may transmit an indication of success in deriving a tuned set of the hyperparameters to the requesting device, along with an indication of that successfully tuned set of hyperparameters. However, if at 1044, the one or more prediction models were trained during these iterations of tuning of hyperparameters for the AI model in response to the received request, then before making such a transmission at 1046, at 1045, the processor may store configuration data representative of that training for each prediction model of the one or more prediction models to enable advantage to be taken of that training in future hyperparameter tuning iteration.

However, if at 1042, the processor does not determine that the predictions were accurate enough and/or if the processor determines that none of the sets of hyperparameters within that batch meets the evaluation criteria, then the processor may evaluate the degree of inaccuracy and/or failure to meet the evaluation criteria. More specifically, at 1048, if the processor determines that the predictions are inaccurate enough and that all of the sets of hyperparameters within that batch fail to meet the evaluation criteria by a great enough degree, then the processor may transmit an indication of success in the tuning of the hyperparameters being unlikely to the requesting device at 1049. This may be based on a presumption that these factors indicate that it is not possible for the hyperparameters to converge sufficiently.

However, if at 1048, the processor determines that the predictions are not quite so inaccurate and/or that one or more sets of hyperparameters within the batch does not fail to meet the evaluation criteria to quite such a degree, then the processor may return to generating another batch of sets of hyperparameters at 1010.

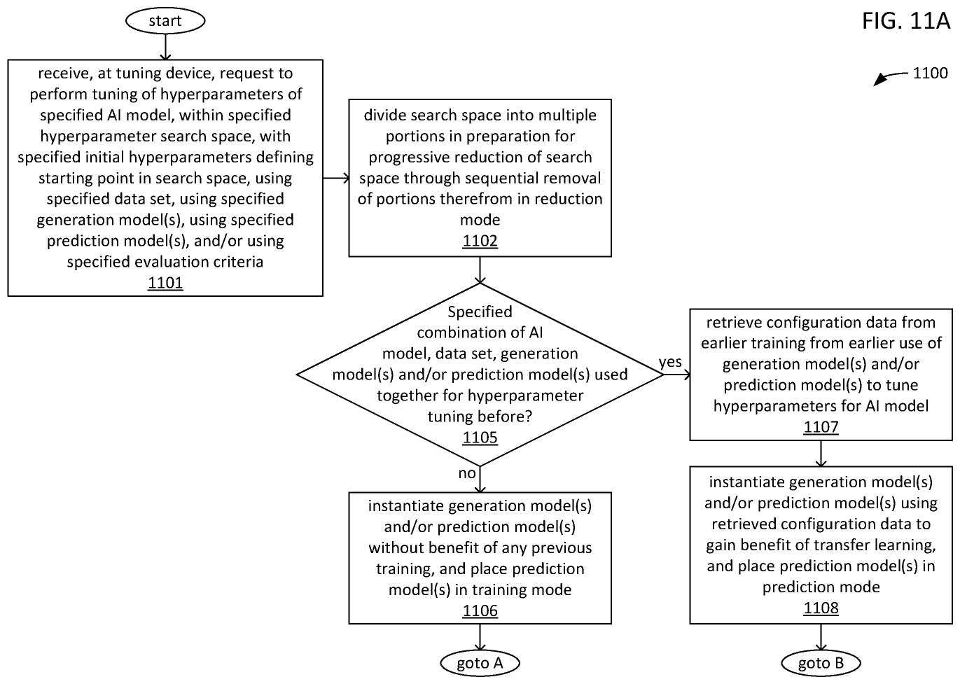

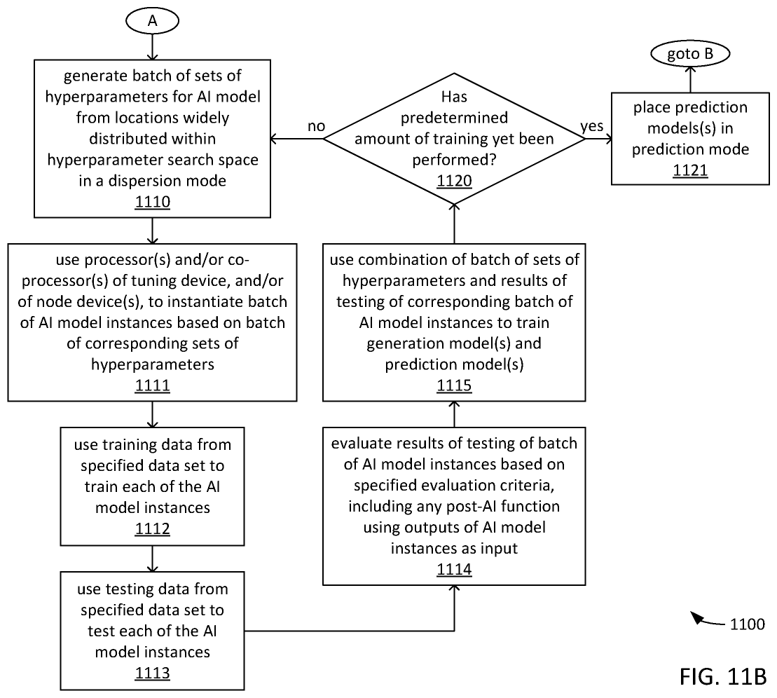

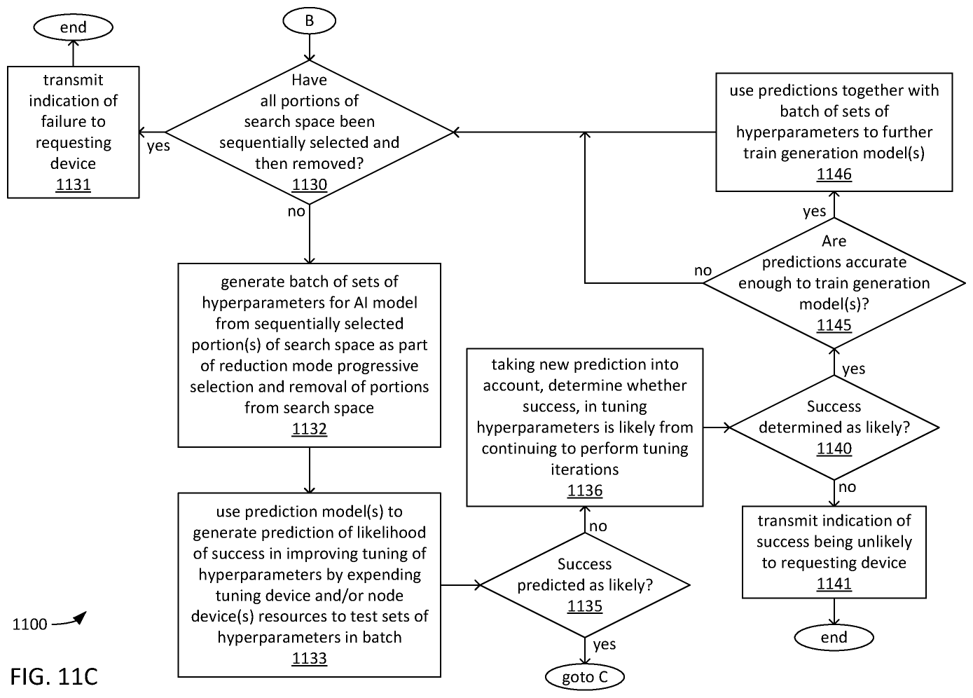

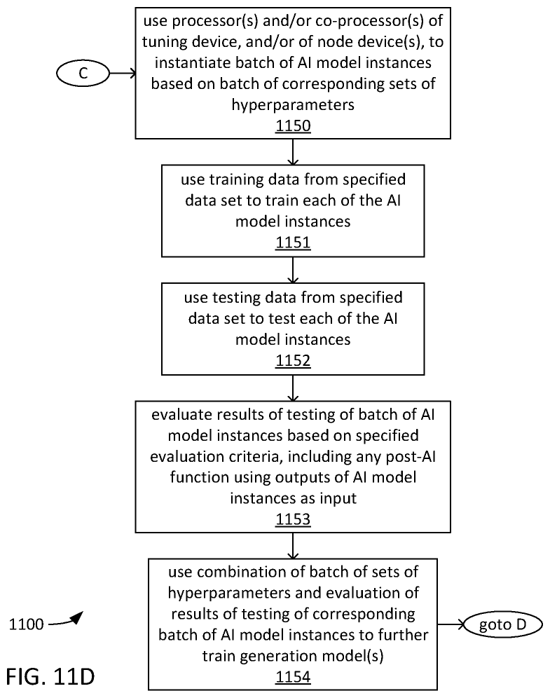

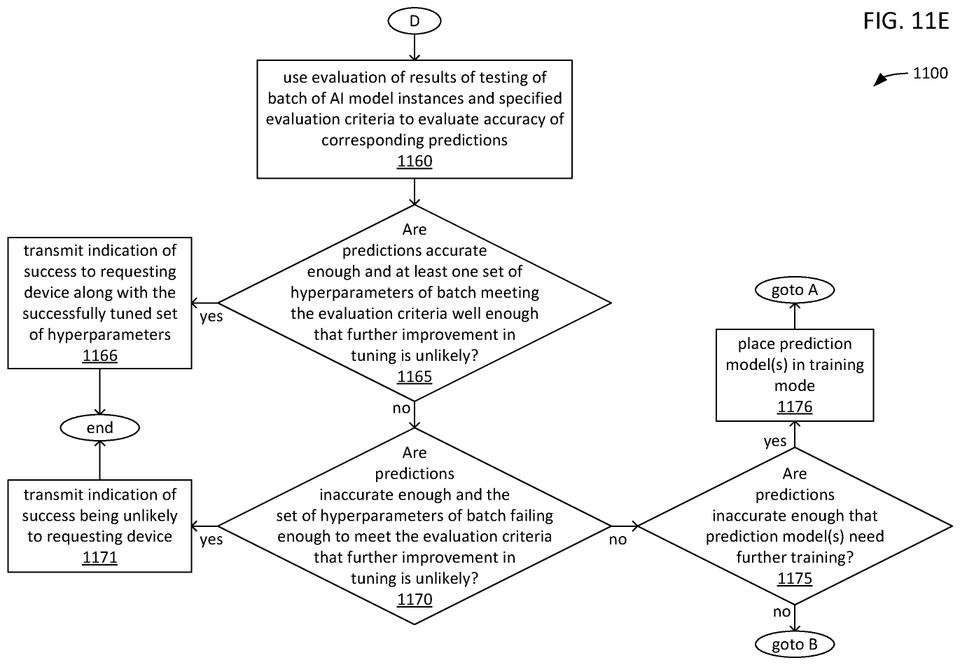

FIGS. 11A through 11E, taken together, illustrate an embodiment of a logic flow 1100. The logic flow 1100 may be representative of some or all of the operations executed by one or more embodiments described herein. For example, the logic flow 1100 may include some or all of the operations performed to tune hyperparameters of an AI model. However, embodiments are not limited in this context.

At 1101, a processor of a tuning device of a system may receive, from a requesting device, a request to perform a tuning of the hyperparameters of an AI model. The request may including information specifying the type and/or other aspects of the AI model, the boundaries of the hyperparameter search space to which the tuning of the hyperparameters is to be limited, an initial set of hyperparameters that define a starting point within the hyperparameter search space at which the tuning is to begin, an identifier of a data set from which training data and/or testing data is to be provided for use in the performance of tuning, the one or more generation models to be used in generating the sets of hyperparameters from within the search space, the one or more prediction models to be used in making predictions concerning the efficacy of further iterations of tuning, and/or evaluation criteria by which aspects of the success of the performance and/or the efficacy of continuing with the performance may be determined.

At 1102, the processor may divide the hyperparameter search space into multiple portions thereof in preparation for performing a progressive reduction of the search space to enhance the hyperparameter tuning by sequentially selecting portions of the hyperparameter search space from which to generate the sets of hyperparameters, and then removing portions the hyperparameter search space from which relatively few (if any) sets of hyperparameters are received that aid in hyperparameter tuning. As previously discussed, such a division of the hyperparameter search space may entail the selection of one of the hyperparameters that may have a larger range of values than others of the hyperparameters, and dividing that range of values of that selected one of the hyperparameters into multiple subranges, thereby effectively dividing the hyperparameter search space along the corresponding dimension.

At 1105, if the particular combination of the specified type of AI model, specified data set, specified one or more generation models, and/or specified one or more prediction models has not been used together, before, in tuning hyperparameters for the specified type of AI model, then at 1106, the processor may instantiate the generation model(s) that are to be used in generating sets of hyperparameters for each iteration of the tuning, and/or the prediction model(s) that are to be used in controlling the performance of iterations of the tuning, and do so without the benefit of any transfer learning from a previous training associated with any previous performance of hyperparameter tuning. Upon being so instantiated, the one or more prediction models may be placed by the processor into a training mode, during which the prediction model(s) may be trained in preparation for being used to make predictions.

However, if at 1105, the particular combination of the specified type of AI model, specified data set, the specified generation model(s) and/or specified prediction model(s) has been used together, before, in previous iterations of performance of tuning hyperparameters for the specified type of AI model, then at 1107, the processor may retrieve configuration data that is representative of what was learned by the one or more prediction models during that previous use to gain the benefit of the earlier training associated with that previous use through transfer learning. At 1108, the processor may then use that configuration data to instantiate the generation model(s) and/or the prediction model(s) with the benefit of the training from that previous use. Upon being so instantiated, the one or more prediction models may be placed by the processor into the prediction mode.

At 1110, the processor may employ any of a wide variety of hyperparameter generation techniques to generate a batch of sets of hyperparameters for the AI model that may correspond to points that are widely dispersed within the boundaries of the hyperparameter search space in a dispersion mode, as has been previously discussed.

At 1111, either the processor (and/or other processor(s) and/or co-processor(s)) of the tuning device may be used to instantiate a batch of instances of the AI model based on the batch of sets of hyperparameters just generated at 1110, or the processor(s) and/or co-processor(s) of one or more node devices may be caused to do so. As previously discussed, the determination of which of such processor(s) and/or co-processor(s) to use may be determined at least by the availability of processor(s) and/or co-processor(s) within one or more node devices (if one or more node devices are present). At 1112, the processor(s) and/or co-processor(s) of the tuning device and/or of the node device(s) may then use a training data taken from the specified data set to train each of the instances of the AI model. At 1113, the processor(s) and/or co-processor(s) of the tuning device and/or of the node device(s) may use testing data taken from the specified data set to test each of the instances of the AI model, and in so doing, effectively test each of the sets of hyperparameters within the batch of sets of hyperparameters.

At 1114, regardless of whether resources of the tuning device or of one or more node devices were used to instantiate, train and test the batch of instances of the AI model, the processor of the tuning device may employ the specified evaluation criteria to evaluate the results of such testing. As has been discussed, in some embodiments, such an evaluation of testing may entail evaluating the outputs of each of the instances of the AI model, directly, while in other embodiments, such an evaluation of testing may entail evaluating an output of a post-AI function that accepts the outputs of an instance of the AI model as its inputs. At 1115, the processor may use the combination of the batch of sets of hyperparameters and the results of the evaluation of the testing of the corresponding batch of instances of the AI model as training data to train the one or more generation models, and/or the one or more prediction models.

At 1120, the processor of the tuning device may check whether a predetermined amount of the training of the one or more prediction models in the training mode has yet been performed. As previously discussed, any of a variety of criteria may be used to trigger the transition of the one or more prediction models from the training mode and into a prediction mode in which the one or more prediction models are used to generate predictions concerning the efficacy of performances of iterations of the tuning of the hyperparameters. Such criteria may include, and is not limited to, a predetermined quantity of training data (e.g., a predetermined quantity of batches of sets of hyperparameters generated in a manner that is widely dispersed throughout the hyperparameter search space, etc.) used to train the one or more prediction models, the passage of a predetermined amount of time since the performance of the tuning of hyperparameters commenced, etc. As also previously discussed, where the sets of hyperparameters generated for use during the training mode are generated to be widely dispersed throughout the hyperparameter search space, it may be that the criteria for transitioning the prediction model(s) from the training mode to the prediction mode includes a requirement of achieving a predetermined degree of density of the dispersed coverage of the sets of hyperparameter all throughout the hyperparameter search space.

If, at 1120, the processor determines that the criteria for a transition from the training mode to the prediction mode have not yet been met, then the processor may again generate a batch of sets of hyperparameters in the dispersion mode at 1110. However, if at 1120, the processor determines that the criteria for a transition from the training mode to the prediction mode have been met, then the processor may place the one or more prediction models into the prediction mode at 1121.

At 1130, the processor of the tuning device may check whether all of the portions into which hyperparameter search space was divided at 1102 have been sequentially selected for use in generating sets of hyperparameters generated therefrom, followed by being ruled out of being further so used as part of the generation of sets of hyperparameters in the reduction mode. More specifically, and as previously discussed, the processor may check, at 1130, whether the hyperparameter search space has been reduced during the reduction mode to such an extent that there are no more of those portions remaining to be so selected, used, and then ruled out. If, at 1130, all of those portions have been so selected, used and then ruled out, then it may be deemed to be the case that a sufficient quantity of sets of hyperparameters that sufficiently cover the entirety of the hyperparameter search space have been considered that it can be said that there is no likelihood of success in tuning the hyperparameters of the AI model, at least under the conditions specified in the request. As a result, the processor may cease any further performance of the hyperparameter tuning, and may transmit an indication of failure in the tuning of the hyperparameters to the requesting device at 1131.

However, it should be noted that, where the prediction mode is being entered into for the first time during the performance of hyperparameter tuning, then none of the portions into which the hyperparameter search space was divided will have yet been so selected and used. Thus, if at 1130, not all of the portions into which the hyperparameter search space has been divided have been so selected, used and then ruled out, then the processor may proceed with such selection, use and ruling out of those portions, one at a time in a sequential manner, starting at 1132.

More specifically, at 1132, the processor may employ any of a wide variety of hyperparameter generation techniques to generate a batch of hyperparameters for the AI model within the boundaries of sequentially selected ones of the multiple portions into which the hyperparameter search space was divided at 1102. As previously discussed, where the prediction mode is being entered for the first time during the performance of hyperparameter tuning, then none of the portions have yet been selected, and the set of hyperparameters specified in the request as defining the starting point of hyperparameter tuning is to be among the first batch of sets of hyperparameters to be generated. As a result, the portion of the hyperparameter search space that includes that starting point may be the first portion to be selected to be the portion from which the first batch of sets of hyperparameters is to be generated.

At 1133, the processor may use the one or more prediction models to make predictions concerning the efficacy of expending time, as well as processing and/or storage resources (of the tuning device and/or of one or more node devices) to test the multiple sets of hyperparameters in the batch just generated at 1132. More precisely, predictions may be made of whether such an expenditure of time and/or other resources is likely to beget test results that will indicate that at least one of the sets of hyperparameters within the batch is successfully an improvement over previous sets of hyperparameters that have been tested such that the evaluation criteria for successfully deriving a set of hyperparameters is at least closer to being met such that an improvement in the tuning of hyperparameters of the AI model has been successfully made.

At 1135, if such success is not predicted to be likely, then the processor may make a determination at 1136 of whether success in further improving the tuning of the set of hyperparameters is likely from continuing to perform further iterations of the tuning. If, at 1140, such success is determined to be unlikely, then the processor may transmit an indication of success in the tuning of the hyperparameters being unlikely to the requesting device at 1141.

However, if at 1140, such success is determined to be likely, then the processor may check, at 1145, whether the accuracy of the predictions has yet been determined to be high enough for the predictions to be used in further training the one or more generation models (e.g., whether the accuracy of the predictions made by the prediction model(s) has yet risen to meet a threshold of accuracy predetermined to be a condition for using the predictions as a basis for such further training). If so, then at 1146, the processor may so use the predictions together with the batch of sets of hyperparameters generated at 1132 to further train the one or more generation models. As previously discussed, in the reduction mode, the generation model(s) implement the machine learning that is employed to progressively reduce the hyperparameter search space from which further sets of hyperparameters are generated, and therefore, it may be deemed desirable to condition the use of the predictions made by the prediction model(s) on whether a determination has yet been made that they are accurate enough for such use. Regardless of the determination concerning the accuracy of the prediction model(s) at 1145, the processor may next be caused to again check whether all of the portions of the hyperparameter search space have already been selected, used and removed from consideration at 1130 in anticipation of again generating a batch of sets of hyperparameters at 1132.

At 1150, either the processor (and/or other processor(s) and/or co-processor(s)) of the tuning device may be used to instantiate a batch of instances of the AI model based on the batch of sets of hyperparameters just generated at 1132, or the processor(s) and/or co-processor(s) of one or more node devices may be caused to do so. Again, the determination of which of such processor(s) and/or co-processor(s) to use may be determined at least by the availability of processor(s) and/or co-processor(s) within one or more node devices (if one or more node devices are present). At 1151, the processor(s) and/or co-processor(s) of the tuning device and/or of the node device(s) may then use a training data taken from the specified data set to train each of the instances of the AI model. At 1152, the processor(s) and/or co-processor(s) of the tuning device and/or of the node device(s) may use testing data taken from the specified data set to test each of the instances of the AI model, and in so doing, effectively test each of the sets of hyperparameters within the batch of sets of hyperparameters.

At 1153, regardless of whether resources of the tuning device or of one or more node devices were used to instantiate, train and test the batch of instances of the AI model, the processor of the tuning device may employ the specified evaluation criteria to evaluate the results of such testing. Again, such an evaluation of testing may entail evaluating the outputs of each of the instances of the AI model, directly, while in other embodiments, such an evaluation of testing may entail evaluating an output of a post-AI function that accepts the outputs of an instance of the AI model as its inputs. At 1154, the processor may use the combination of the batch of sets of hyperparameters and the results of the evaluation of the testing of the corresponding batch of instances of the AI model as training data to train the one or more generation models.

At 1160, the processor may use the evaluation of the results of the testing of the batch of instances of the AI model along with the specified evaluation criteria to evaluate the accuracy of the corresponding predictions that were made at 1133 prior to the instantiation, training and testing of that batch of instances. If at 1165, the processor determines that the predictions are accurate enough (based on the evaluation criteria), and that at least one of the sets of hyperparameters within that batch thereof meets the evaluation criteria well enough that further improvement through further iterations of the performance of tuning of hyperparameters is deemed to be unlikely, then at 1166, the processor may cease any further performance of the hyperparameter tuning, and may transmit an indication of success in deriving a tuned set of the hyperparameters to the requesting device, along with an indication of that successfully tuned set of hyperparameters.

However, if at 1165, the processor does not determine that the predictions were accurate enough and/or if the processor determines that none of the sets of hyperparameters within that batch meets the evaluation criteria, then the processor may evaluate the degree of inaccuracy and/or failure to meet the evaluation criteria. More specifically, if at 1170, the processor determines that the predictions are inaccurate enough and that all of the sets of hyperparameters within that batch fail to meet the evaluation criteria by a great enough degree, then at 1171, the processor may cease any further performance of the hyperparameter tuning, and may transmit an indication of success in the tuning of the hyperparameters of the AI model being unlikely to the requesting device at 1171. This may be based on a presumption that these factors indicate that it is not possible for the hyperparameters to converge sufficiently.

However, if at 1170, the processor determines that the predictions are not quite so inaccurate and/or that one or more sets of hyperparameters within the batch does not fail to meet the evaluation criteria to quite such a degree, then at 1175, the processor may next check whether the predictions are still inaccurate enough that the one or more prediction models are in need of further training (e.g., whether the accuracy of the predictions made by the prediction model(s) has either never risen to meet or has fallen below a threshold of accuracy predetermined to be a trigger to commence such further training). If so, then the processor may place the prediction model(s) back into the training mode at 1176, before returning to generating a batch of sets of hyperparameters in the dispersion mode at 1110. If not, then the processor may be caused to again check whether all of the portions of the hyperparameter search space have already been selected, used and removed from consideration as part of continuing the reduction mode at 1130 in anticipation of again generating a batch of sets of hyperparameters at 1132.

In various embodiments, the predetermined threshold of accuracy checked for at 1145 and required as a condition to use prediction in further training the one or more generation models at 1146 may be selected to be lower than, higher than, or the same as the threshold checked for at 1165 and required as one of the conditions to terminate further performance of the hyperparameter tuning at 1166. In various embodiments, the predetermined threshold of accuracy checked for at 1175 and required as a condition to avoiding further training of the one or more prediction models at 1176 may be selected to be lower than, higher than, or the same as the threshold checked for at 1170 and used as part of one of the conditions to terminate further performance of the hyperparameter tuning at 1171.

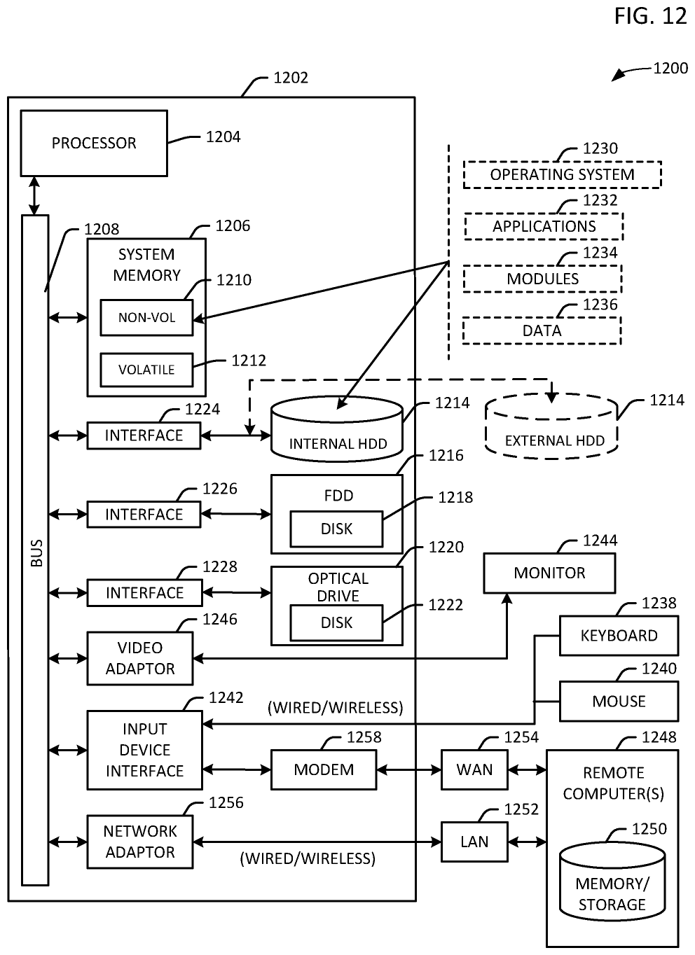

FIG. 12 illustrates an embodiment of an exemplary computing architecture 1200 comprising a computing system 1202 that may be suitable for implementing various embodiments as previously described. In various embodiments, the computing architecture 1200 may comprise or be implemented as part of an electronic device. In some embodiments, the computing architecture 1200 may be representative, for example, of a system that implements one or more components of the system 100. In some embodiments, computing system 1202 may be representative, for example, of the devices 102, 103, 104 and/or 105 of the system 100. The embodiments are not limited in this context. More generally, the computing architecture 1200 may be configured to implement the logic, applications, systems, methods, GUIs, apparatuses, and functionality described herein with reference to the preceding figures.

As used in this application, the terms “system” and “component” and “module” are intended to refer to a computer-related entity, either hardware, a combination of hardware and software, software, or software in execution, examples of which are provided by the exemplary computing architecture 1200. For example, a component can be, but is not limited to being, a process running on a computer processor, a computer processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing system 1202 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing system 1202.

More specifically, the computing system 1202 comprises a processor 1204, a system memory 1206 and a system bus 1208. The processor 1204 can be any of various commercially available computer processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi processor architectures may also be employed as the processor 1204.

The system memory 1206 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. Further, as depicted, the system memory 1206 can include non-volatile memory 1210 and/or volatile memory 1212. A basic input/output system (BIOS) may be stored in the non-volatile memory 1210.

The system bus 1208 provides an interface for system components including, but not limited to, the system memory 1206 to the processor 1204. The system bus 1208 can be any of several types of bus structure that may further interconnect to a memory bus (with or without a memory controller), a peripheral bus, and a local bus using any of a variety of commercially available bus architectures. Interface adapters may connect to the system bus 1208 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing system 1202 may include various types of computer-readable storage media in the form of one or more lower speed memory units, including an internal (or external) hard disk drive (HDD) 1214, a magnetic floppy disk drive (FDD) 1216 to read from or write to a removable magnetic disk 1218, and/or an optical disk drive 1220 to read from or write to a removable optical disk 1222 (e.g., a CD-ROM or DVD). The HDD 1214, FDD 1216 and/or optical disk drive 1220 may be connected to the system bus 1208 by an HDD interface 1224, an FDD interface 1226 and/or an optical drive interface 1228, respectively. The HDD interface 1224 for external drive implementations may include at least one or both of Universal Serial Bus (USB) and IEEE 1394 interface technologies. The computing system 1202 is generally is configured to implement all logic, systems, methods, apparatuses, and functionality described herein with reference to the preceding figures.

The drives and associated computer-readable media provide volatile and/or nonvolatile storage of data, data structures, computer-executable instructions, and so forth. For example, a number of program modules can be stored in the drives and memory units 1210 and/or 1212, including and not limited to, an operating system 1230, one or more application programs 1232, other program modules 1234, and program data 1236. In one embodiment, the one or more application programs 1232, other program modules 1234, and/or program data 1236 may include, for example, the various applications and/or components of the system 100, e.g., the control routines 240, 340, 440 and/or 540.

A user may enter commands and information into the computing system 1202 through one or more wired/wireless input devices, such as, for example, a keyboard 1238 and/or a pointing device, such as a mouse 1240. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. Such other input devices may be connected to the processor 1204 through an input device interface 1242 that is coupled to the system bus 1208, and/or may be connected via other interfaces such as a parallel port, IEEE 1394 serial port, a game port, a USB port, an IR interface, and so forth.

A monitor 1244 or other type of display device may also connected to the system bus 1208 via an interface, such as a video adaptor 1246. The monitor 1244 may be internal or external to a casing of the computing system 1202. Still other peripheral output devices may be coupled to the computing system 1202, including and not limited to, speakers, printers, and so forth.

The computing system 1202 may operate in a networked environment using logical connections via wired and/or wireless communications to one or more remote computers 1248. Such a remote computer 1248 may be a workstation, a server computer, a router, a personal computer, portable computer, microprocessor-based entertainment appliance, a peer device or other common network node, and typically includes many or all of the elements described relative to the computing system 1202, although, for purposes of brevity, only a memory/storage device 1250 is illustrated. The logical connections may include wired/wireless connectivity to a local area network (LAN) 1252 and/or larger networks, such as a wide area network (WAN) 1254. Such LAN and WAN networking environments are commonplace in offices and companies, and facilitate enterprise-wide computer networks, such as intranets, each of which may connect to a global communications network, for example, the Internet. In various embodiments, the network 109 may be one or more of the LAN 1252 and the WAN 1254.

When used in a LAN networking environment, the computing system 1202 may be connected to the LAN 1252 through a wired and/or wireless communication network interface or adaptor 1256. The adaptor 1256 can facilitate wired and/or wireless communications to the LAN 1252, which may also include a wireless access point disposed thereon for communicating with the wireless functionality of the adaptor 1256.

When used in a WAN networking environment, the computing system 1202 may include a modem 1258, or may be connected to a communications server on the WAN 1254, or may have other means for establishing communications over the WAN 1254, such as by way of the Internet. The modem 1258, which may be internal or external to a casing of the computing device 1202, and may be a wired and/or wireless device, may connect to the system bus 1208 via the input device interface 1242. In a networked environment, program modules depicted relative to the computing system 1202, or portions thereof, may be stored in the remote memory/storage device 1250. It will be appreciated that the network connections shown are exemplary and other means of establishing a communications link between the depicted computers can be used.

The computing system 1202 may be operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity) and WiMax wireless technologies, and/or still other wireless technologies such as Bluetooth™. Thus, such communications may employ a standards-based predefined structure as with a conventional network, or may simply employ ad hoc communication between at least two devices. Such Wi-Fi networks may use radio technologies commonly referred to as IEEE 802.11x (a, b, g, n, etc.) to provide secure, reliable, fast wireless connectivity. Such a Wi-Fi network can be used to connect computers to each other, to the Internet, and/or to wired networks (which use IEEE 802.3-related media and functions).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A non-transitory computer-readable medium storing instructions configured to cause a processor to:
receive, from a requesting device, a request to perform hyperparameter tuning of hyperparameters of an artificial intelligence (AI) model;
divide a hyperparameter search space into multiple search space portions;
train, using machine learning, a generation model to determine whether a search space portion is likely to provide a set of hyperparameters that improves a success metric by which success of the hyperparameter tuning is evaluated;
sequentially select at least a subset of the multiple search space portions, wherein for each search space portion that is selected, the processor is caused to:
generate at least one set of hyperparameters from the search space portion;
perform the hyperparameter tuning with the at least one set of hyperparameters as an input to determine whether the at least one set of hyperparameters improved the success metric;
based at least on the determination of whether the at least one set of hyperparameters improved the success metric, apply the generation model to determine whether the search space portion is likely to provide another set of hyperparameters that improves the success metric; and
rule out the search space portion from providing further sets of hyperparameters in response to a determination that the search space portion is unlikely to provide another set of hyperparameters that improves the success metric; and
terminate the performance of the hyperparameter tuning when all search space portions of the multiple search space portions are ruled out from providing further sets of hyperparameters.

2. The medium of claim 1, wherein:
the performance of the hyperparameter tuning comprises use of processing and storage resources to instantiate an instance of the AI model with a set of hyperparameters from among the at least one set of hyperparameters, to train the instance with training data, and to test the instance with testing data to test the set of hyperparameters to determine whether the set of hyperparameters improves the success metric; and
the medium further stores instructions that cause the processor to:
train, using machine learning, a prediction model during a training mode to determine whether continuing the performance of hyperparameter tuning will cause an improvement in the success metric; and
after the training of the prediction model during the training mode, perform operations comprising:
based at least on the evaluation of whether the set of hyperparameters improved the success metric, apply the prediction model during a prediction mode to determine whether continuing the performance of hyperparameter tuning will cause an improvement in the success metric; and
terminate the performance of hyperparameter tuning in response to:
an accuracy of the prediction model in predicting improvement in the success metric is below a predetermined low accuracy threshold, and none of the sets of hyperparameters of the at least one set of hyperparameters that has been tested has yet improved the success metric to meet the criteria threshold; or
the accuracy of the prediction model is above a predetermined high accuracy threshold, and a determination that continuing the performance of hyperparameter tuning will not cause an improvement in the success metric.

3. The medium of claim 2, further storing instructions that cause the processor, for at least one search space portion of the subset that is sequentially selected, to:
apply the prediction model during the prediction mode to generate a prediction of whether the use of the processing and storage resources to perform the hyperparameter tuning with the at least one set of hyperparameters generated from the at least one search space portion as an input will improve the success metric; and
in response to a prediction that the success metric will be improved, perform operations comprising:
use the processing and storage resources to perform the hyperparameter tuning with the at least one set of hyperparameters generated from the at least one search space portion as input to generate an output;
evaluate the output to determine whether the success metric is improved; and
further train, by machine learning, the generation model using the at least one set of hyperparameters and the evaluation of the output.

4. The medium of claim 3, further storing instructions that cause the processor, in response to the prediction that the success metric will be improved, to:
determine the accuracy of the prediction model based at least on the evaluation of the output; and
further train the prediction model, in a return to the training mode from the prediction mode, and using machine learning, based on whether the accuracy of the prediction model is below a prediction training accuracy threshold.

5. The medium of claim 3, further storing instructions that cause the processor, in response to a prediction that the success metric will not be improved and based on whether the accuracy of the prediction model has been found to be above a generation training accuracy threshold, to further train, by machine learning, the generation model using the at least one set of hyperparameters and the prediction that the success metric will not be improved.

6. The medium of claim 1, wherein:
the request comprises an indication of an initial set of hyperparameters that define a starting point within a single search space portion of the multiple search space portions within the hyperparameter search space; and
the medium further stores instructions that cause the processor to begin the sequential selection of at least the subset of the multiple search space portions with the single search space portion that includes the starting point.

7. The medium of claim 1, wherein, for each search space portion of the subset that is sequentially selected:
the generation of at least one set of hyperparameters from the search space portion comprises generation of a batch of sets of hyperparameters comprising a predetermined quantity of sets of hyperparameters;
the performance of hyperparameter tuning with the at least one set of hyperparameters as an input comprises the performance of the hyperparameter tuning with each set of hyperparameters of the batch of sets of hyperparameters; and
the application of the generation model to determine whether the search space portion is likely to provide another set of hyperparameters that improves the success metric comprises an evaluation of each set of hyperparameters of the batch of sets of hyperparameters.

8. A computer-implemented method comprising:
receiving, from a requesting device, a request to perform hyperparameter tuning of hyperparameters of an artificial intelligence (AI) model;
dividing a hyperparameter search space into multiple search space portions;
training, using machine learning, a generation model to determine whether a search space portion is likely to provide a set of hyperparameters that improves a success metric by which success of the hyperparameter tuning is evaluated;
sequentially selecting at least a subset of the multiple search space portions, wherein for each search space portion that is selected, the processor is caused to:
generating at least one set of hyperparameters from the search space portion;
performing the hyperparameter tuning with the at least one set of hyperparameters as an input to determine whether the at least one set of hyperparameters improved the success metric;
based at least on the determination of whether the at least one set of hyperparameters improved the success metric, applying the generation model to determine whether the search space portion is likely to provide another set of hyperparameters that improves the success metric; and
ruling out the search space portion from providing further sets of hyperparameters in response to a determination that the search space portion is unlikely to provide another set of hyperparameters that improves the success metric; and
terminating the performance of the hyperparameter tuning when all search space portions of the multiple search space portions are ruled out from providing further sets of hyperparameters.

9. The method of claim 8, wherein:
performing the hyperparameter tuning comprises using processing and storage resources to instantiate an instance of the AI model with a set of hyperparameters from among the at least one set of hyperparameters, to train the instance with training data, and to test the instance with testing data to test the set of hyperparameters to determine whether the set of hyperparameters improves the success metric; and
the method further comprises:
training, using machine learning, a prediction model during a training mode to determine whether continuing to perform hyperparameter tuning will cause an improvement in the success metric; and
after the training of the prediction model during the training mode, performing operations comprising:
based at least on the evaluation of whether the set of hyperparameters improved the success metric, applying the prediction model during a prediction mode to determine whether continuing to perform hyperparameter tuning will cause an improvement in the success metric; and
terminating the performing of hyperparameter tuning in response to:
an accuracy of the prediction model in predicting improvement in the success metric is below a predetermined low accuracy threshold, and none of the sets of hyperparameters of the at least one set of hyperparameters that has been tested has yet improved the success metric to meet the criteria threshold; or
the accuracy of the prediction model is above a predetermined high accuracy threshold, and a determination that continuing the performance of hyperparameter tuning will not cause an improvement in the success metric.

10. The method of claim 9, further comprising, for at least one search space portion of the subset that is sequentially selected, performing operations comprising:
applying the prediction model during the prediction mode to generate a prediction of whether the use of the processing and storage resources to perform the hyperparameter tuning with the at least one set of hyperparameters generated from the at least one search space portion as an input will improve the success metric; and
in response to a prediction that the success metric will be improved, performing operations comprising:
using the processing and storage resources to perform the hyperparameter tuning with the at least one set of hyperparameters generated from the at least one search space portion as input to generate an output;
evaluating the output to determine whether the success metric is improved; and
further training, by machine learning, the generation model using the at least one set of hyperparameters and the evaluation of the output.

11. The method of claim 10, further comprising, in response to the prediction that the success metric will be improved, performing operations comprising:
determining the accuracy of the prediction model based at least on the evaluation of the output; and
further training the prediction model, in a return to the training mode from the prediction mode, and using machine learning, based on whether the accuracy of the prediction model is below a prediction training accuracy threshold.

12. The method of claim 10, further comprising, in response to a prediction that the success metric will not be improved and based on whether the accuracy of the prediction model has been found to be above a generation training accuracy threshold, further training, by machine learning, the generation model using the at least one set of hyperparameters and the prediction that the success metric will not be improved.

13. The method of claim 8, wherein:
the request comprises an indication of an initial set of hyperparameters that define a starting point within a single search space portion of the multiple search space portions within the hyperparameter search space; and
the method comprises beginning the sequential selection of at least the subset of the multiple search space portions with the single search space portion that includes the starting point.

14. The method of claim 8, wherein, for each search space portion of the subset that is sequentially selected:
generating at least one set of hyperparameters from the search space portion comprises generating a batch of sets of hyperparameters comprising a predetermined quantity of sets of hyperparameters;
performing hyperparameter tuning with the at least one set of hyperparameters as an input comprises performing hyperparameter tuning with each set of hyperparameters of the batch of sets of hyperparameters; and
applying the generation model to determine whether the search space portion is likely to provide another set of hyperparameters that improves the success metric comprises evaluating each set of hyperparameters of the batch of sets of hyperparameters.

15. An apparatus comprising a processor, and a storage communicatively coupled to the processor, and that stores instructions configured to cause the processor to:
receive, from a requesting device, a request to perform hyperparameter tuning of hyperparameters of an artificial intelligence (AI) model;
divide a hyperparameter search space into multiple search space portions;
train, using machine learning, a generation model to determine whether a search space portion is likely to provide a set of hyperparameters that improves a success metric by which success of the hyperparameter tuning is evaluated;
sequentially select at least a subset of the multiple search space portions, wherein for each search space portion that is selected, the processor is caused to:
generate at least one set of hyperparameters from the search space portion;
perform the hyperparameter tuning with the at least one set of hyperparameters as an input to determine whether the at least one set of hyperparameters improved the success metric;
based at least on the determination of whether the at least one set of hyperparameters improved the success metric, apply the generation model to determine whether the search space portion is likely to provide another set of hyperparameters that improves the success metric; and
rule out the search space portion from providing further sets of hyperparameters in response to a determination that the search space portion is unlikely to provide another set of hyperparameters that improves the success metric; and
terminate the performance of the hyperparameter tuning when all search space portions of the multiple search space portions are ruled out from providing further sets of hyperparameters.

16. The apparatus of claim 15, wherein:
the performance of the hyperparameter tuning comprises use of processing and storage resources to instantiate an instance of the AI model with a set of hyperparameters from among the at least one set of hyperparameters, to train the instance with training data, and to test the instance with testing data to test the set of hyperparameters to determine whether the set of hyperparameters improves the success metric; and
the processor is further caused to:
train, using machine learning, a prediction model during a training mode to determine whether continuing the performance of hyperparameter tuning will cause an improvement in the success metric; and
after the training of the prediction model during the training mode, perform operations comprising:
based at least on the evaluation of whether the set of hyperparameters improved the success metric, apply the prediction model during a prediction mode to determine whether continuing the performance of hyperparameter tuning will cause an improvement in the success metric; and
terminate the performance of hyperparameter tuning in response to:
an accuracy of the prediction model in predicting improvement in the success metric is below a predetermined low accuracy threshold, and none of the sets of hyperparameters of the at least one set of hyperparameters that has been tested has yet improved the success metric to meet the criteria threshold; or
the accuracy of the prediction model is above a predetermined high accuracy threshold, and a determination that continuing the performance of hyperparameter tuning will not cause an improvement in the success metric.

17. The apparatus of claim 16, wherein the processor is further caused, for at least one search space portion of the subset that is sequentially selected, to:
apply the prediction model during the prediction mode to generate a prediction of whether the use of the processing and storage resources to perform the hyperparameter tuning with the at least one set of hyperparameters generated from the at least one search space portion as an input will improve the success metric; and
in response to a prediction that the success metric will be improved, perform operations comprising:
use the processing and storage resources to perform the hyperparameter tuning with the at least one set of hyperparameters generated from the at least one search space portion as input to generate an output;
evaluate the output to determine whether the success metric is improved; and
further train, by machine learning, the generation model using the at least one set of hyperparameters and the evaluation of the output.

18. The apparatus of claim 17, wherein the processor is further caused, in response to the prediction that the success metric will be improved, to:
determine the accuracy of the prediction model based at least on the evaluation of the output; and
further train the prediction model, in a return to the training mode from the prediction mode, and using machine learning, based on whether the accuracy of the prediction model is below a prediction training accuracy threshold.

19. The apparatus of claim 17, wherein the processor is further caused, in response to a prediction that the success metric will not be improved and based on whether the accuracy of the prediction model has been found to be above a generation training accuracy threshold, to further train, by machine learning, the generation model using the at least one set of hyperparameters and the prediction that the success metric will not be improved.

20. The apparatus of claim 15, wherein:
the request comprises an indication of an initial set of hyperparameters that define a starting point within a single search space portion of the multiple search space portions within the hyperparameter search space; and
the processor is further caused to begin the sequential selection of at least the subset of the multiple search space portions with the single search space portion that includes the starting point.
